(19) United States
(12) Patent Application Publication
(10) Pub. No.: US 2012/0160209 A1
(43) Pub. Date: Jun. 28, 2012

(54) TURBINE HAVING COOPERATING AND COUNTER-ROTATING ROTORS IN A SAME PLANE

(76) Inventor: Bobby BOUCHER, Havre-Saint-Pierre (CA)

(21) Appl. No.: 12/975,729

(22) Filed: Dec. 22, 2010

(51) Int. Cl. F02B 53/00; F01C 1/24; F01C 1/18

(52) U.S. Cl. 123/200; 418/206.1; 418/196

(57) ABSTRACT

The present disclosure relates to turbine comprising a housing having an input port and at least one output port. The turbine also comprises two rotors enclosed within the housing. The rotors counter-rotate within a same plane. In their rotation, the two rotors cooperate to create chambers within the housing. A chamber is created and starts to expand while another chamber having been created earlier continues its own expansion. One of these expanding chambers is connected to the input port. A third chamber is in contact with an output port. The turbine may be used as a compressor, an energy generator, a pump or as a building block of a motor.

### TECHNICAL FIELD

This present disclosure relates to the field of energy conversion, and more specifically, to a turbine having cooperating and counter-rotating rotors.

### BACKGROUND

Most combustion engines and most compressors use one or more pistons alternating within cylinders to produce torque or to compress a gas. The ubiquitous alternating piston engine generates volume variation, which is required both in motor or compressor applications, in an inefficient manner. Due to heavy losses inherent to its alternating mode, this engine generates tremendous heat, suffers from important levels of friction, vibrates, generates shocks at high pressure levels and high temperatures, and is noisy. The overall thermal efficiency of a typical alternating piston engine used in an automotive application is very low, typically in the range of 25%.

In a four-cycle engine, the fact that the four strokes (intake, compression, combustion, exhaust) take place within a same volume, delimited by the movement of the piston within its cylinder, is a major conceptual limitation to the efficiency of the motor: An ideal volume for one stroke, for example admission, is not necessarily the ideal volume for another stroke, for example expansion during combustion. At the top-dead center of its revolution, the engine creates high pressure levels and high temperatures while not producing any torque, leading to heavy heat transfer towards the engine block, thereby reducing the efficiency of the engine. Moving parts such as pistons and connecting rods need to be very rigid and heavy in order to withstand heat shocks, pressure shocks, and constant acceleration/deceleration cycles. Additionally, high pressure coupled with high-heat points within the cylinders form a condition that is prone to the formation of nitrous oxide (NOx), an important pollutant. The quasi-sinusoidal movement produced by pistons, crankshafts and like components lead to an uneven output torque produced by the engine. The addition of a heavy flywheel is required for smoothing the output torque of such conventional engine. The engine needs to evacuate a large fraction of the generated energy to the atmosphere, with limited evacuation restriction. The engine is thus very noisy because exhaust gases are pulsed and expelled from the engine at well above atmospheric pressures. Compressor applications wherein, for example, an electric motor drives one or more pistons, generally suffer from most of the same inconveniences.

Rotary engines such as the well-known Wankel motor only partially overcome the above-mentioned deficiencies of the alternating piston engines. Rotary engines rely on heavy, eccentrically rotating pistons that still generate considerable vibrations due to the constant shift of the mass of the rotating pistons. Moreover, in comparison to the traditional alternating piston engine, the Wankel engine suffers from important fuel and lubricating oil consumption. This engine requires the use of seals for preventing burning gases from reaching gases that are in their compression phase; failure of these seals have plagued many rotary engine applications. Friction is also an important problem of the Wankel engine.

Traditional turbines such as those used in aircrafts or in thermal power plants are very complex and too costly for most applications. These turbines need to operate at very high rotating speeds and are only efficient within a very limited range of operating speeds in order to ensure that gases enter at a precise velocity. Due to its architecture comprising fans operating in aerodynamic mode, it is not possible to create pressure within a traditional turbine at a low rotating speed. Additionally, traditional turbines become fragile when exposed to non-ideal conditions; for example a turbine used in nuclear or thermal power plant may be severely impacted when subject to “unclean” vapor containing small droplets of water. These droplets may severely erode the fans of the turbine.

Therefore, there is a need for an improved turbine capable of compressing or pumping a fluid and/or generating torque, at improved energy efficiency levels, the turbine having a low production cost.

### SUMMARY

Therefore, according to the present disclosure, there is provided a turbine for use in energy generation, energy recovery, motor, pump, and compressor applications.

According to an aspect of the present disclosure, there is also provided a turbine comprising a housing having a perimeter connected to a top and a bottom, an input port and at least one output port. The turbine also comprises two counter-rotating spiral-shaped rotors enclosed within the housing, each rotor having an axis of rotation. The rotors have a thickness allowing slightly spaced or barely contacting relation with the top and the bottom of the housing. The rotors also have four curved arms. The arms of a first rotor are curved in a direction of rotation of the first rotor while the arms of a second rotor are also curved in the direction of rotation of the first rotor. A diameter of each one of the rotors extends in length for slightly spaced or barely contacting relation of a tip of the arms to the perimeter of the housing over at least 90 degrees of rotation of the rotors. A distance between the two axes is such that the tip of an arm of the first rotor comes in slightly spaced or barely contacting relation between two arms of the second rotor at some angle of rotation. As the two rotors rotate, chambers are formed between some of the arms of the two rotors and between some of the arms and the perimeter of the housing, in continuously varying shapes. Volumes of the chambers delimited by theses shapes are further delimited by the top and the bottom of the housing. A first chamber defined between some arms of the two rotors and the perimeter of the housing is in an expansion phase when a second chamber is created and starts to expand between some arms of the two rotors. One of the first and second chambers is in connection with the input port. The first and second chambers are expanding while at least a third chamber is in connection with the at least one output port.

The present disclosure further relates to a turbine comprising a housing having an input port and at least one output port and two rotors enclosed within the housing. The rotors are counter-rotating in a same plane. A plurality of chambers are formed within the housing and delimited by arms of the rotors. The arms of the rotors cooperate in their rotation to create a first chamber and a second chamber, the first chamber and the second chamber concurrently expanding as the rotors rotate, the first chamber starting to expand earlier than the second chamber. One of the first and second chambers is in connection with the input port. A third chamber is in contact with the at least one output port.

The present disclosure also relates to a motor, comprising a combustion turbine. The combustion turbine comprises a housing having an input port and at least one output port, two rotors enclosed within the housing and counter-rotating in a same plane, a plurality of chambers formed within the housing and delimited by arms of the rotors, an ignition mechanism, and an output shaft is operably connected to at least one of the two rotors. The arms of the rotors cooperate in their rotation to create a first chamber, the first chamber and at least a second chamber concurrently expanding as the rotors rotate, the second chamber starting to expand earlier than the first chamber, one of the first and second chambers being in connection with the input port, a third chamber being in contact with the at least one output port. The motor also comprises a compression turbine operating in reverse mode from the combustion turbine for admitting and compressing an air and fuel mixture and for providing the compressed air and fuel mixture to the input port of the combustion turbine. A synchronization shaft is operably connected to each turbine. Torque from at least one of the two rotors is received at the output shaft.

### BRIEF DESCRIPTION OF THE DRAWINGS

Embodiments of the disclosure will be described by way of example only with reference to the accompanying drawings, in which:

FIG. 1 is a perspective view of parts of a turbine according to an embodiment;

FIGS. 2, 3, 4, 5 and 6 show schematic top views of the turbine of FIG. 1 with rotors positioned at five consecutive rotation angles;

FIG. 7 is a partial perspective view of a housing bottom according to an embodiment;

FIG. 7a is a cutaway view of a housing bottom according to an embodiment;

FIG. 7b is a partial view of the housing bottom of FIG. 7, showing placement of a rotating valve;

FIG. 8 is a graph of relative torque values as a function of rotation angles;

FIG. 9 is a partial perspective view of a rotor according to an embodiment;

FIG. 10 is a perspective view of an rotor according to another embodiment;

FIG. 11 is a partial perspective view of an rotor according to yet another embodiment;

FIG. 12 is a photograph of some components of a turbine prototype;

FIG. 13 is a second photograph of components of the turbine prototype;

FIG. 14 is a perspective view showing some parts of a motor according to an embodiment;

FIG. 14a is a partial cutaway view of the motor of FIG. 14;

FIG. 14b is another partial cutaway view of the motor of FIG. 14;

FIG. 14c is a detailed view of a bottom part of the motor of FIG. 14;

FIG. 15 is another perspective view showing additional parts of the motor of FIG. 14;

FIG. 15a is yet another perspective view showing additional parts of the motor of FIG. 14;

FIG. 16 is a perspective view showing details of the motor of FIG. 14;

FIG. 17 is a perspective view showing the complete motor of FIG. 14; and

FIG. 18 is a schematic view of an alternate embodiment of a turbine.

### DETAILED DESCRIPTION

The present disclosure is directed to a turbine that may be used as a pump, a compressor, as an energy recuperation device for generating torque, an air engine, a steam turbine, or as a part of a motor. A basic turbine comprises a housing that encloses two counter-rotating and cooperating spiral-shaped rotors. Each rotor has a plurality of curved arms, or blades, for example four (4) arms. While the rotors are counter-rotating, the arms of both rotors are curved in a same direction. For example, the arms of a first rotor and the arms of a second rotor may both be curved in a direction of rotation of the first rotor. The rotors rotate within a same plane, within the housing. The rotors have a width, or depth that closely matches a distance between two substantially parallel internal surfaces of the housing. The internal surfaces of the housing may be flat or substantially flat in order to maximize areas of contact between these surfaces and the rotors. The rotors also have an overall diameter, defined by a circumference covered by a full rotation of a tip of the curved arms. An internal perimeter of the housing may be generally shaped as two partially overlapping circles having a circumference generally matching the circumference of the rotors.

Because the width of the rotors closely matches the distance between the two parallel internal surfaces of the housing, a relation between the rotors may be characterized as “edging”, in the sense that a balance is attained between a minimal friction between the surfaces and a minimal gaseous leakage. The tips of the arms of the rotors may thus come in slightly spaced or barely contacting relation—hereinafter edging contact—with the internal perimeter of the housing. Edging contact of a tip of a curved arm may be made with the internal surface of the housing over at least 90 degrees of rotation. The two rotors may also come in edging contact with each other. A distance between axes of rotation of the two rotors is such that the tip of an arm of one rotor comes in contact with the other rotor, in a void between its own two arms, at some rotation angles.

In an embodiment, minimal friction is attained between barely contacting parts of the turbine. In another embodiment, a slight spacing is maintained between the various parts of the turbine. Some spacing may allow minimal leak between, for example, the arms of the rotors and the parallel interface surfaces of the housing. Turbulence between fixed and mobile parts minimizes further such leaks. This effect, which is well-known to those skilled in the art of conventional high-speed turbines, is in fact applicable in the turbine of the present disclosure.

From the following description of various embodiments, the skilled reader will observe that no strict tolerance of various dimensions of the components of the turbine is required, as some internal leakage is not detrimental to the operation of the turbine. Additionally, some embodiments disclosed hereinbelow reveal how leakage may be controlled and how adverse aerodynamic effects may be circumvented.

The housing is generally sealed except for at least one input port and one or more output ports. Multiple chambers, or cavities, are defined within the housing by the cooperation of the rotors: the chambers have a volume delimited in one dimension by the two parallel internal surfaces of the housing and in the other two dimensions by varying combinations comprising the arms of the rotors and the perimeter of the housing. Because the rotors are rotating, the chambers continuously change in size and in shape. As the rotors rotate, new chambers are continuously created and expand while other chambers reduce in size and disappear.

The creation of a new chamber may cause, as it expands, a negative pressure. When the negative pressure is present at the input port, a gas—or more generally a fluid, including for example a gas comprising a part of liquid droplets—may be aspirated into the expanding chamber. Likewise, a chamber that is reducing in size acquires a higher pressure and may expel gas through an output port. A chamber that, at a given time, maintains a constant size may also expel gas through an output port if the chamber has been pressurized earlier. Hence, if an external mechanical force or torque is applied to the turbine and engages the rotors in a rotating motion, the turbine may act as a compressor or as a pump.

A pressurized fluid may alternatively be applied at the input port. The pressurized fluid forces the expansion of a chamber by rotation of the rotors. The pressure of the fluid is reduced as the chamber expands and may then be expelled at a lower pressure at an output port. Hence, the turbine may be used to convert the pressure of the fluid applied at the input port into an output torque. This property of the turbine may be used in an electrical power plant.

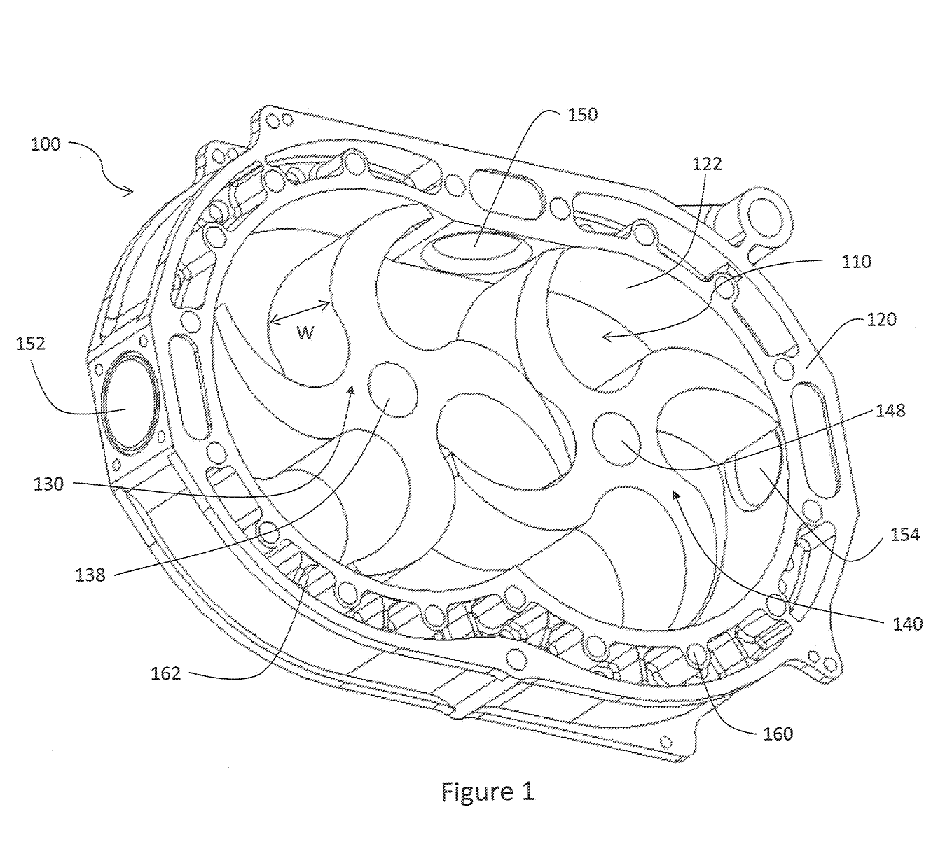

Referring to FIG. 1, there is shown a perspective view of parts of a turbine according to an embodiment. The turbine 100 comprises a housing that further comprises a bottom part 110, a top part (not shown) substantially parallel to the bottom part 110, a perimeter 120 having an internal surface 122, two rotors 130 and 140 having axes 138 and 148. The turbine 100 may operate in various positions, and those of ordinary skill in the art will appreciate that mentions of a “top” and a “bottom” of the turbine 100 are relative to the turbine 100 as a whole and are made for convenience of illustration. In an embodiment, a shape of the top part may mirror the shape of the bottom part 110. The rotors are counter-rotating: the rotor 130 may rotate clockwise around its axis 138 and the rotor 140 may rotate counterclockwise around its axis 148. The direction of rotation of the rotors could be reversed, depending on desired functions and characteristics of the turbine 100. The rotors have a width W, or depth, corresponding substantially to a distance between the bottom part 110 and the top part of the housing, allowing for some tolerance for minimizing or eliminating friction. The exemplary turbine 100 also comprises at least one input port (not shown, but visible on later figures) and one or more output ports. The exemplary turbine 100 comprises a central output port 150 and two lateral output ports 152, 154. As shown, the output ports 150-154 are located within the perimeter 120 of the housing. In other embodiments, diverse numbers of output ports may be located in other parts of the perimeter 120, in the bottom part 110, in the top part, or in various placement combinations within the housing. A description of the operation of the turbine 100 found hereinbelow provides insights on proper locations of the input port and output port(s). The exemplary turbine 100 as shown further comprises other parts, such as holes 160 within the perimeter 120 for the passage of bolts (not shown) for holding the various parts of the housing together, and apertures 162 adapted for the passage of liquid or gaseous cooling fluids. Other elements may be present in the turbine 100, such as for example sealing gaskets, for example o-rings, between the top part, perimeter and bottom part, valves for opening and closing the input and output ports, passages for coolants within and between the bottom part 110 and the top part, as is well-known in the art. In an embodiment, the perimeter may be integral with one of the top or bottom part of the housing. O-rings and grooves may be used for sealing between fixes components, thereby reducing the effect of machining tolerances upon components assembly. A volume adapted to receive a cooling fluid may be, in the case of a vapor turbine, filled with an isolating material for preventing heat losses. The same space may also be used for capturing vapor losses or condensation of the vapor. Leaks may thus be recuperated from an outlet located near the bottom of the turbine.

The housing, comprising the top part, the bottom part 110 and the perimeter 120, may be generally sealed, apart from the various input and output ports. The rotors 130 and 140 are held in place at their axes 138 and 148 of rotation by rotating shafts (not shown), which prevent lateral movement of the rotors 130 and 140 but allow rotational movement. In an embodiment, each of the rotors 130 or 140 and its respective axe 138 or 148 may be machined as one single piece, providing higher resistance to mechanical forces, higher reliability, limiting mechanical movement between the rotors and their axes, and further allowing higher pressures within the turbine 100. The rotors 130 and 140 do not significantly move perpendicularly to the axes because their width W is more or less equal, within some mechanical tolerance to the distance between the top and bottom parts. External components such as bearings (not shown) connected to the rotating shafts may further be used to maintain the rotors 130, 140 in place. In their rotation, the rotors 130, 140 may come in edging contact with each other, with the top part and the bottom part 110, and with the internal surface 122 of the perimeter 120. In contrast with traditional engines, mechanical tolerances between the rotors 130, 140 and the internal surface 122 may be relatively relaxed: various “spaces”, called “chambers” formed between the rotors themselves or between the rotors and the housing may withstand a modest level of leakage without adverse effect on the operation and performance of the turbine 100. As illustrated on FIG. 1, the width W, or depth, of the rotors 130, 140 and the surface 122 are perpendicular to the top part and bottom part 110 of the housing. In an embodiment, a shape of the rotors 130, 140 may comprise some axial twisting along their width W. Variations from the shape of the rotors 130, 140 as shown on FIG. 1 will readily come to mind to those of ordinary skill in the art.

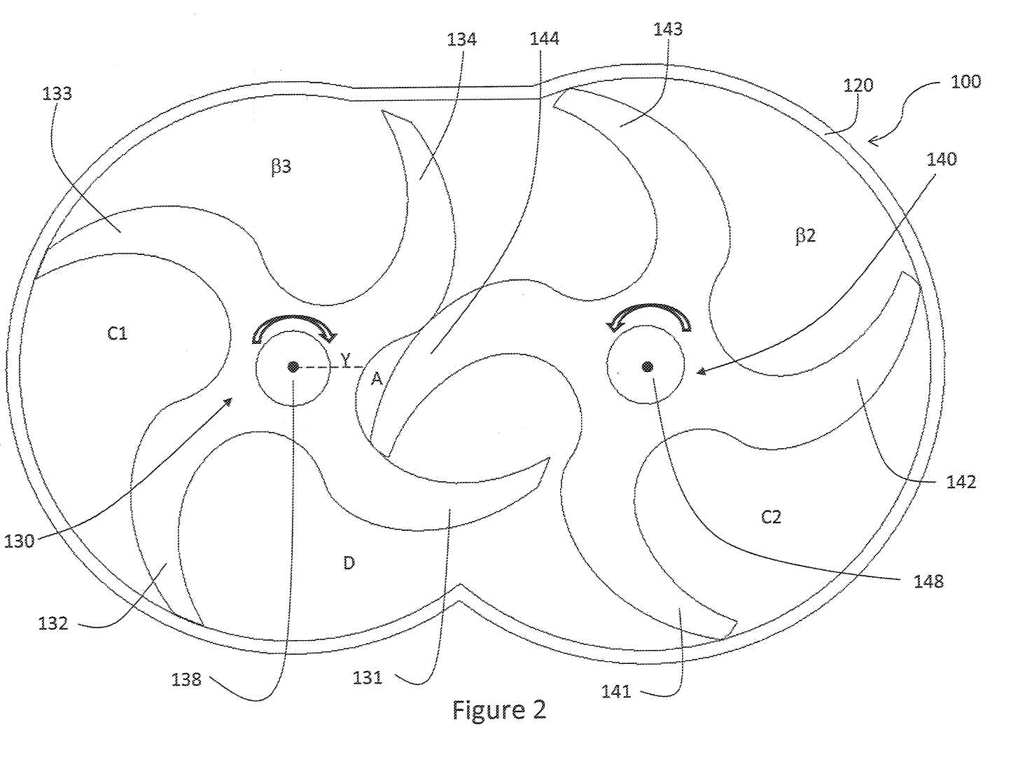

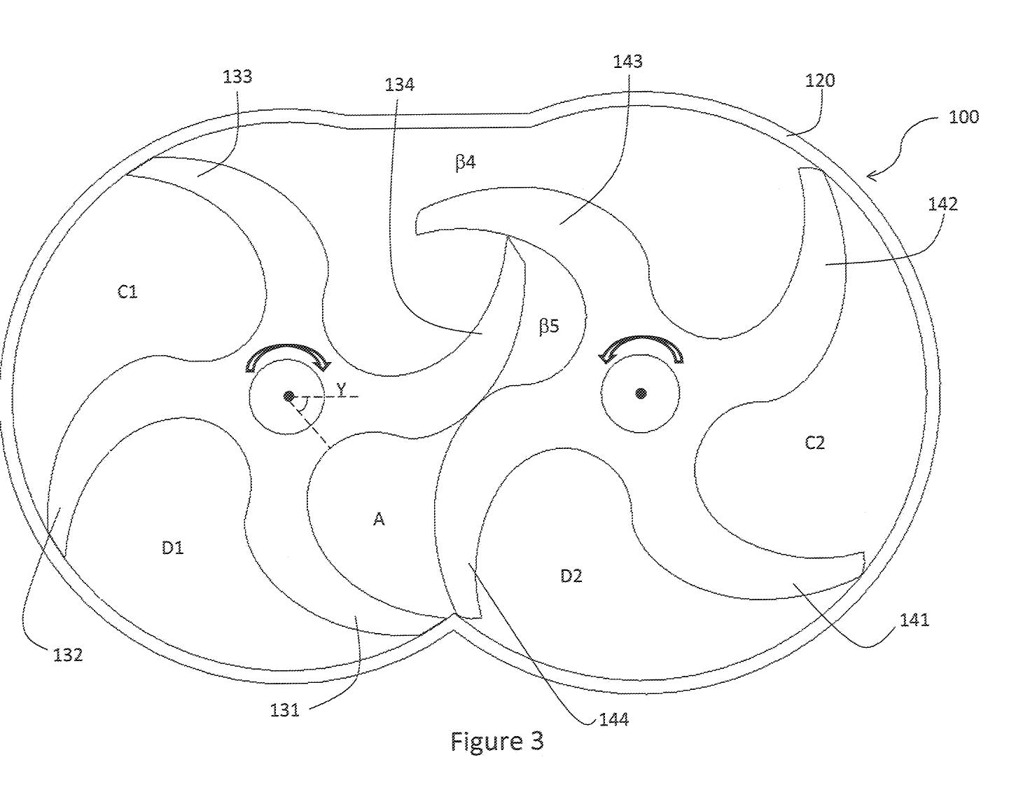

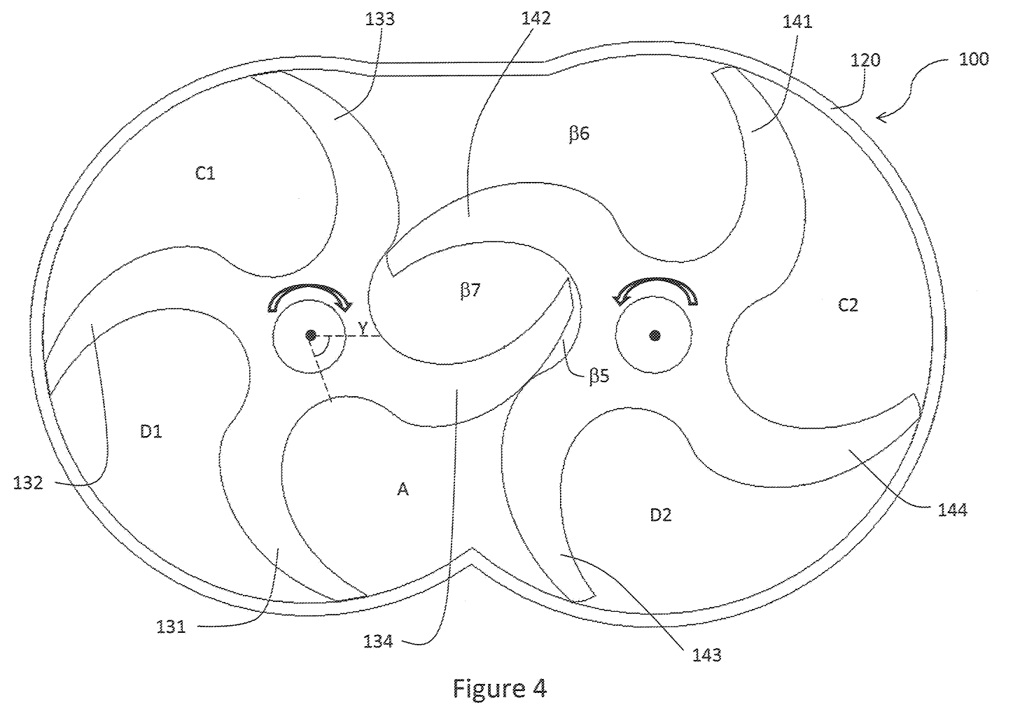

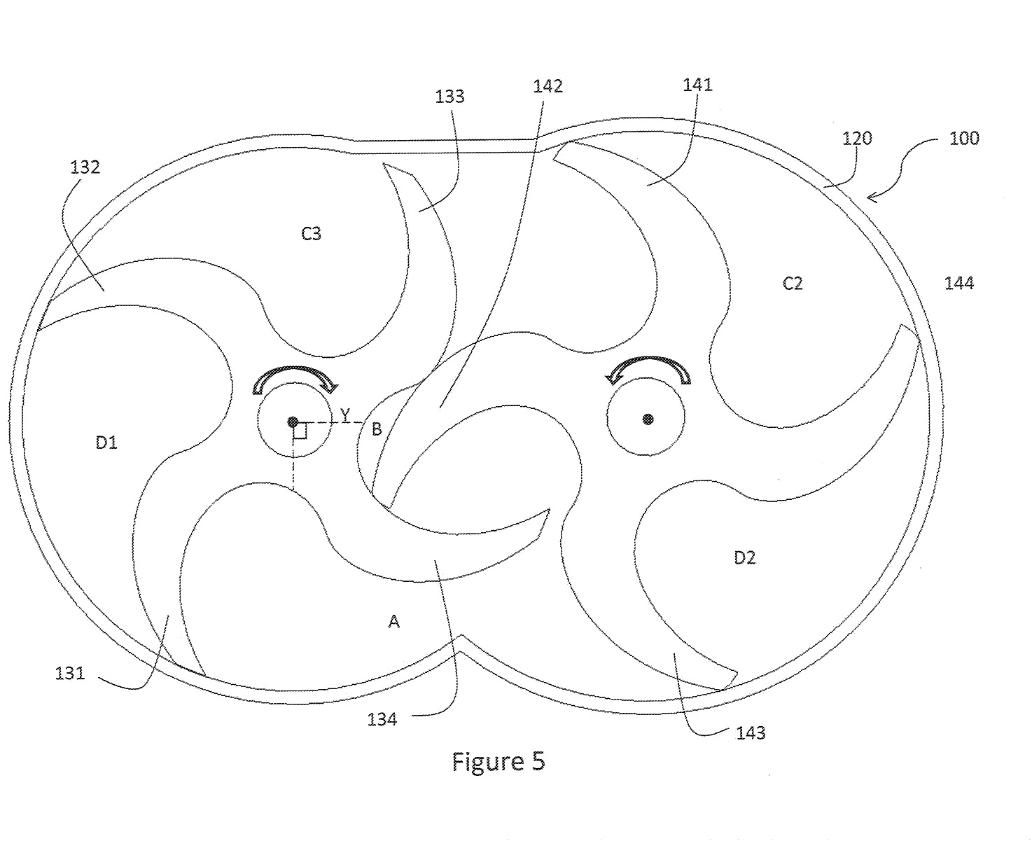

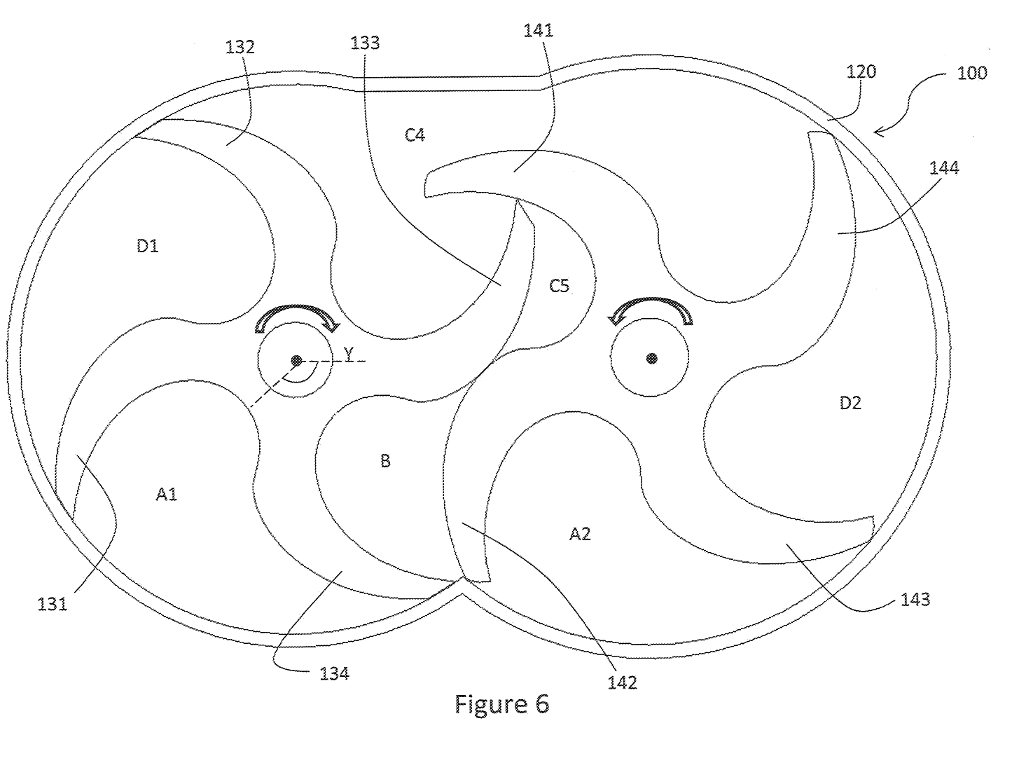

Referring now concurrently to FIGS. 2, 3, 4, 5 and 6 are shown schematic top views of the turbine of FIG. 1 with rotors positioned at five consecutive rotation angles. FIGS. 2-6 collectively illustrate a cycle, in which chambers are created, expand and eventually reduce in size and disappear. The turbine 100 is reproduced in FIGS. 2-6 in schematic form. As shown, the rotor 130 rotates clockwise and the rotor 140 rotates counter-clockwise. An arbitrary reference angle Y is shown near the axis 138, set to a nominal 0-degree (horizontal) value in FIG. 2. Arms, also called blades, of the rotors are identified by use of numerals 131-134 and 141-144. Various chambers are created, expand, move and then disappear as a result of a cooperation of the rotors 130 and 140 as they rotate. Considering FIG. 2, a chamber A is created between an arm 144 and a void of the rotor 130, between arms 131 and 134. Other chambers D, C1, C2, β3 and β2 have been created earlier as the rotors 130 and 140 rotate. While chambers C1 and C2 may appear nearly identical on FIGS. 2-5, it should be understood that chamber C1 and chamber C2 may differ somewhat. Turning then to FIG. 3, which shows the turbine having undergone about 22 degrees of rotation of its rotors compared to FIG. 2 (angle Y is about equal to 22 degrees), the chamber A has increased in volume. On FIG. 3, the chambers β3 and β2 of FIG. 2 have been combined and split again into chambers β4 and β5. Following another about 28 degrees of rotation, the chamber A is now much wider as shown on FIG. 4 (angle Y is about equal to 50 degrees). At the time shown in FIG. 4, the chamber A is no longer delimited solely by arms of the rotors, but also by the perimeter 120. At the same time, the chamber β5 has reduced in size while the chamber β4 is now split into chambers β6 and β7. Adding some more rotation at FIG. 5 (angle Y is about equal to 90 degrees), the chamber A is nearing is maximum volume. Chambers C1 and β6 have merged into chamber C3. Then at FIG. 6 (angle Y is about equal to 130 degrees), the chamber A has been split into two chambers A1 and A2 while chambers C2 and C3 have combined and split again into chambers C4 and C5. Returning to FIG. 5, which shows 90 degrees of rotation compared to FIG. 2, a new chamber B is being created. Chamber B has increased volume in FIG. 6, which shows 90 degrees of rotation compared to FIG. 3.

It may thus be observed that a new chamber is created from the cooperation of the rotors 130, 140 at every 90 degrees of rotation, or four times per revolution of the rotors. Over a complete revolution of the rotors, chambers C, D, A and B have been created near the axis 138 of the rotor 130 and have gone through phases of expansion, splitting into distinct chambers temporarily having a constant volume as for example chambers C1 and C2 of FIG. 2, the chambers having been combined and having their sizes reduced towards the end of their cycles.

Returning to FIG. 2, at the time when chamber A is created and starts expanding, an earlier created chamber D, created at a time when the rotors 130 and 140 had 90 less degrees of rotation, is nearing the end of its own expansion phase. In FIGS. 3-6, chamber D has been split into two chambers D1 and D2. As the rotors rotate between the rotation angles shown on FIGS. 3-6, volumes of the chambers D1 and D2 remain essentially constant.

On FIG. 3, positions of the arms 141 and 144, spanning over the chamber D2, exemplify a minimum 90-degree range of rotation of the rotors over which the tip of the arms are in slightly spaced or barely contacting relation with the perimeter 120 of the housing. As shown, as the rotor 140 continues rotating counterclockwise, the tip of the arm 141 remains substantially in contact with the perimeter 120 over more than 180 degrees. However, in an embodiment, the perimeter may be altered such that contact is lost between the tip of the arm 141 and the perimeter beyond the position shown on FIG. 3 while preserving the functionality of the turbine 100.

Eventually, as the rotors continue turning, split chambers such as D1 and D2 join again. For example, chambers C1 and C2 that have constant volumes in FIGS. 2-4 start joining with remnants of an earlier chamber β3 at FIG. 5. At FIG. 6, a combination of chambers C1, C2 and β3 are split again in chambers C3 and C4.

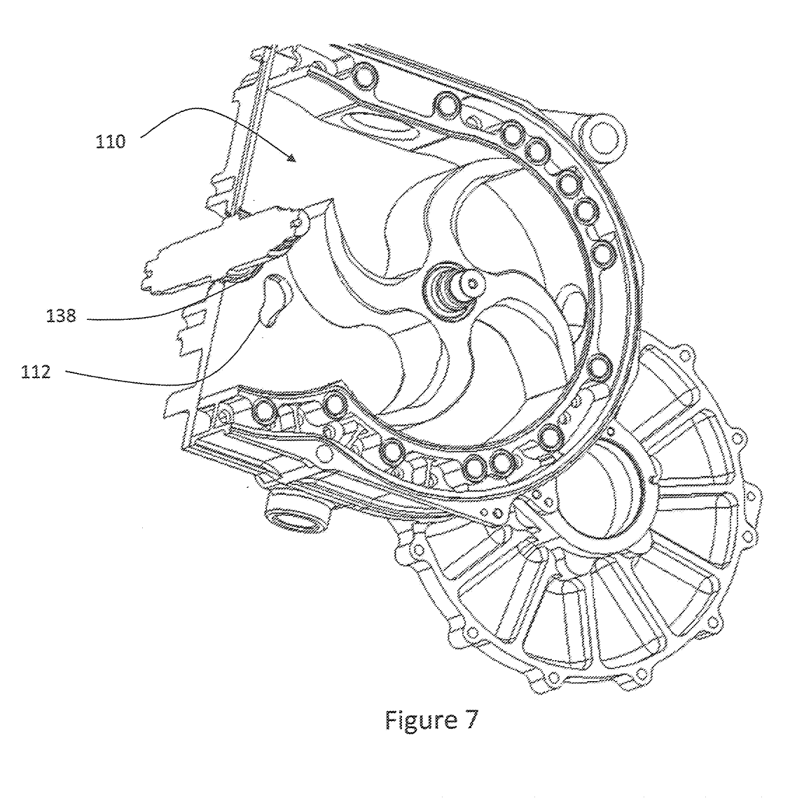

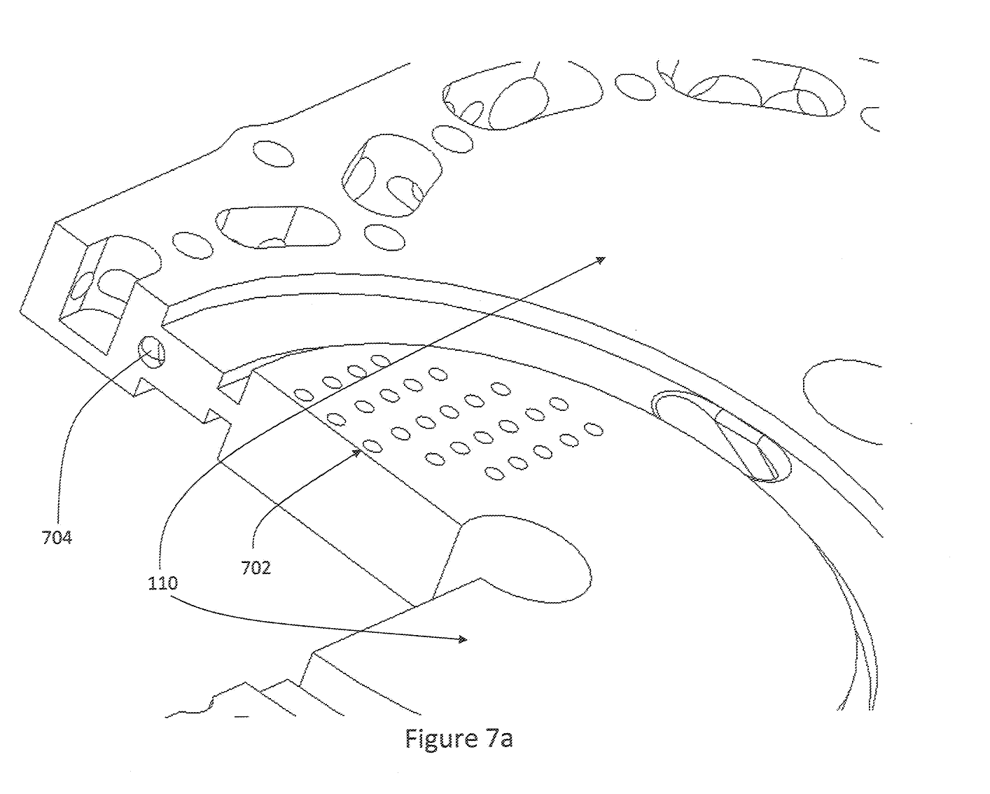

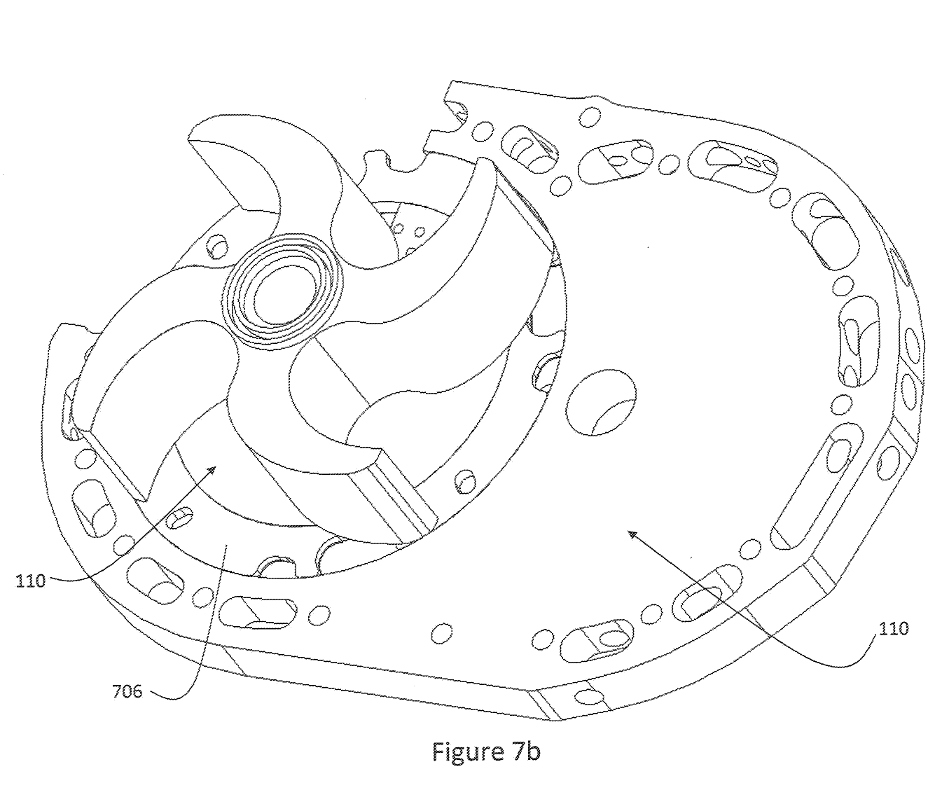

As expressed hereinabove, the housing of the turbine 100 is sealed except for an input port and one or more output ports. An input port may be located in the bottom of the housing, as shown on FIG. 7, which is a perspective view of a housing bottom according to an embodiment. The housing bottom 110 comprises an input port 112. Alternatively, the turbine 100 may comprise more than one input port and the one or more input ports may be located in the bottom of the housing, in the perimeter of the housing, or in the top of the housing. A plurality of input ports may be located in a combination of the bottom, top and perimeter of the housing. Comparing FIGS. 2 and 7, the input port 112 may be located near the axis 138, at area location where the chamber A is initially created and starts to expand. A cooling fluid may circulate in canal 704 within the housing bottom, shown on FIG. 7a, for capturing the absorbed heat. FIG. 7a also shows an array of holes 702, which promote heat absorption within the housing.

The rotors 130 and 140 may be synchronized, for example using synchronizing gears (not shown) located outside of the housing, and connected to axes 138 and 148 via the rotating shafts. Synchronization helps in minimizing friction between the rotors 130, 140 and in maximizing mechanical torque upon the rotating shafts.

In an embodiment, as a chamber expands due to the rotation of the cooperating rotors, a negative relative gas or fluid pressure is created in the expanding chamber. In another embodiment, a positive gas pressure applied in a chamber forces the chamber to expand, creating a force applied to the blades, or arms, of the rotors, creating a torque around the axes of the rotors. It will therefore be apparent to those of ordinary skill in the art that the turbine 100 may be used to convert energy present in a pressurized gas, such as for example water vapor from a boiler in a thermal or nuclear power plant, converting an energy from the pressurized gas into a mechanical torque at the axes of the rotors, usable for example for driving an electric generator.

An embodiment of a torque generator based on the turbine 100 will now be described. The torque generator operates according to the cycle described in relation to FIGS. 2-6. At a time where the rotational position of the rotors corresponds to FIG. 2, the input port 112 is open and provides pressurized gas to the chamber A. Pressure in the chamber A pushes on the arm 144, forcing rotation. As rotation increases, the pressure in chamber A further pushes on the arm 131. This pressure on the arms of the rotors creates a torque at the axes 138 and 148. As the rotors rotate, the chamber B starts being created over the location of the input port 112 and the cycle continues. Some of the chambers have stopped expanding, for example chambers C1 and C2 on FIGS. 2-4. As such, any pressure within those chambers does not create any torque on the rotors 130 and 140. This contrasts with expanding chambers such as chamber A in FIGS. 2-5, wherein the expansion implies pressure and torque on the arms of the rotors. Some of the chambers may eventually start reducing in size, thereby creating compression and creating a counteracting force on the rotors, for example chamber β5 in FIGS. 3-4. To circumvent this effect, one or more output ports such as 150, 152 and 154, shown on FIG. 1 are used in various combinations to release pressure from chambers that are no longer expanding.

In an embodiment, because the pressure within those chambers that are neither expanding nor compressing does not generate any torque, a part of the energy contained within this pressure may be recuperated. Gas from the output ports 150, 152 may be fed into a secondary turbine that also generates some torque. Alternatively, some of the gas from the output ports 150, 152 may be recirculated throughout cooling passages within the housing, thereby reducing the need for other cooling means. Furthermore, when the gas absorbs some additional heat by passing in the cooling passages, its volume expands, increasing an amount of residual enthalpy of the gas, whereby energy can be harnessed by the secondary turbine. This reduces any amount of energy required to cool the turbine 100 while also increasing a net torque output. Those of ordinary skills in the art will appreciate that heat management within the turbine 100 may depend on its intended use. For example, when the turbine 100 is used for generating torque from hot water vapor, heat losses from the turbine 100 may be minimized so that a maximum possible amount of energy is extracted from the vapor.

In an exemplary embodiment of a torque generator, the turbine 100 is not negatively impacted if a gas entering the input port 112 is contaminated with some liquid. As an example, “unclean” vapor containing a significant amount of water droplets may be processed by the turbine 100 without significant adverse effect on the rotors 130, 140. The eventual presence of small water droplets in vapor processed by the turbine 100 may at once provide a level of air tightness between the rotors and the housing while, as rotational speeds of the turbine are relatively low, remaining harmless to the rotors, Some treatment of fixed and mobile components of the turbine 100 may further counteract any erosion effects from such water droplets.

An embodiment of a compressor based on the turbine 100 will now be described. In this embodiment, the turbine 100 operates in a reverse mode compared to the cycle described in relation to FIGS. 2-6. The direction of rotation of the rotors 130 and 140 is reversed and, the output ports 150 and/or 152 and 154 become inputs through which a low pressure gas or fluid enters the turbine 100. Torque is applied to the axes 138 and 148, creating compression of the chambers that eventually meet the input port 112 or any other input port, which become outputs through which pressurized gas is expelled. An understanding of the compressor embodiment of the turbine 100 may be had by considering FIGS. 2-6 in reverse order, wherein the rotor 130 rotates counterclockwise while the rotor 140 rotates clockwise. It will be understood that this also implies that the chamber B is created before chamber A, and that these chambers are contracting, rather than expanding, in a sequence going from FIG. 6 down to FIG. 2. In this compressor, various gas pressures are present in various chambers. Any gas leak from a higher pressure chamber is recuperated in a lower pressure chamber, the leaked gas being compressed again. It may thus be observed that leaks within the compressor bring little adverse effects or losses.

In various embodiments of a torque generator or compressor based on the turbine 100, valves such as alternating valves or rotating valves may be used to control opening of the input port and of the output ports. FIG. 7b shows a rotating valve 706, which is inserted within the bottom 110. The valve may be attached to the rotor 134, optionally allowing a small amount of relative motion therebetween. Rotation of the valve 706 opens and closes the input port 112. Grooves (not shown) may be added to the edges of the valve 706, generating a Bernouilli effect for limiting losses between the bottom 110 and the valve 706.

Instead of a gas, an uncompressible liquid, for example water, may flow through the turbine 100. Though the liquid does not compress, its pressure on the rotors 130, 140 still generates torque. As such, the turbine 100 may be used to generate torque from a flow of water, for example, in a hydroelectric power plant. Likewise, the turbine 100 may be used for pumping a liquid, when operating in reverse mode compared to the cycle described in relation to FIGS. 2-6.

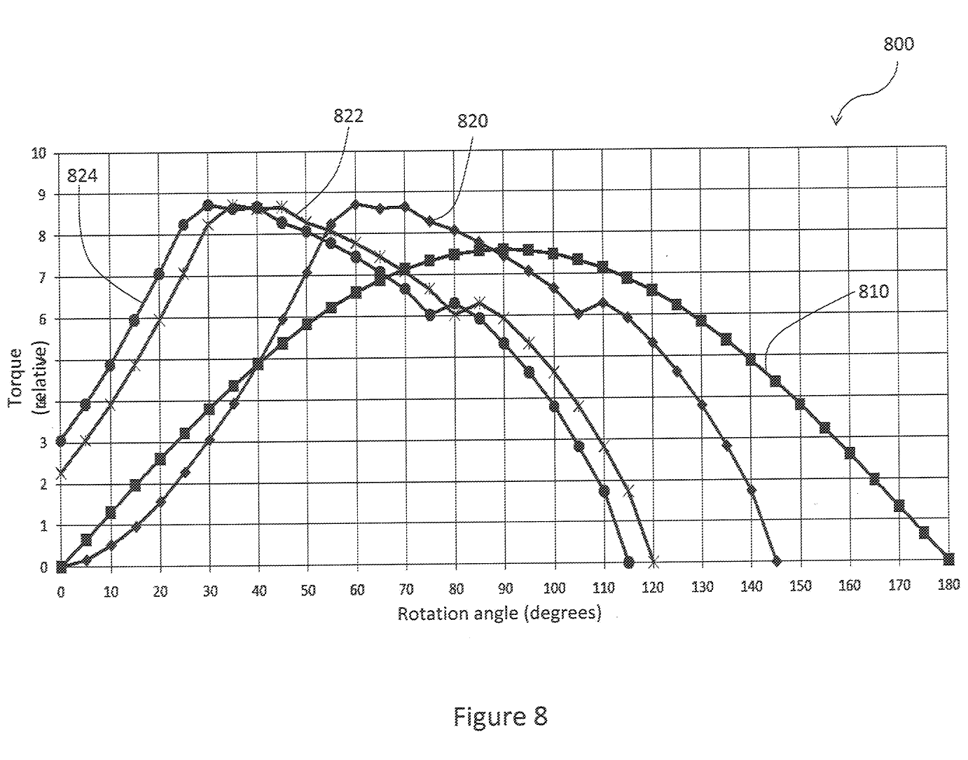

Referring now to FIG. 8, which is a graph of relative torque values as a function of rotation angles, a performance of the turbine 100 is compared to that of a single-cylinder alternating piston motor. For comparison purposes, it is assumed that the turbine 100 is used as a torque generator rather than as a compressor. Full (100%) mechanical efficiency without any mechanical loss is also assumed for the piston motor and for the turbine 100. In the case of the turbine 100, it is assumed that a valve closes the input port 112 when chamber A is in the position as shown on FIG. 2, thereby maintaining a constant pressure within the turbine 100. Torque values shown on the vertical axis of graph 800 are relative in order to allow comparison of any size turbine with an alternating piston motor of any size. The rotation angle of the horizontal axis represents, for the alternating piston motor, a crankshaft angle wherein the zero degree position corresponds to a point where the piston is at the top of the cylinder, generally called “top dead center”, closely following an ignition time of a spark plug that occurs a few degrees before that point. For the turbine 100, the zero degree position corresponds to the creation of a new expanding chamber in the turbine 100, for example a few degrees prior to the rotor positions on FIG. 2.

Curve 810 represents a torque provided by a piston of a conventional engine on its crankshaft. At a zero degree point, the piston is at the top of its course within a cylinder. Because of its position, there is no lever effect from the piston to the crankshaft. Even though a compression within the cylinder is at its maximum and even though ignition occurs shortly before that point, no torque is provided by the piston due to the lack of leverage. The torque provided by the piston is at its maximum when the crankshaft has rotated by 90 degrees. Of course, the piston of a conventional four-stroke motor produces power only once per every two revolutions. Hence the peak torque obtained at 90 degrees is followed by inefficient periods during the next three strokes following the combustion cycle. The piston actually absorbs some torque during the exhaust, admission and compression strokes. As a result, an overall torque curve from the piston is somewhat sinusoidal, including periods during which the net torque output is negative.

The turbine 100 creates chambers that generate torque over about 145 degrees of rotation, new chambers being generated four (4) times per revolution, which implies that periods of time in which two successive chambers generate torque may overlap, the torque from the two chambers being combined at the axes. Referring again to FIG. 2, Chamber A has just been created; the 0-degree reference angle Y of FIG. 2 thus represents a few degrees of rotation after a true 0-degree angle. The true 0-degree angle represents a point where a new chamber is starting to be generated, initially without any volume. FIG. 6 shows a point when chamber A has just been split into chambers A1 and A2, which no longer generate any torque, and thus represent a few degrees after a true 145-degree point, this point being defined as where a chamber is no longer expanding, being split into two chambers. Considering again FIG. 8, curve 820 shows a torque produced by the turbine 100 from a true 0-degree angle to a true 145-degree. It may be observed on curve 820 that the turbine 100 provides a peak torque at about 60 degrees of rotation, earlier than a conventional piston that peaks around 90 degrees of rotation. Torque is produced until a chamber stops expanding, at about 145 degrees of rotation. Curves 822 and 824 represent torque produced by the turbine 110 when pressurized gas or fluid is input into the turbine sometime after the start of expansion of a chamber. In those cases, it can be seen that the torque appears as soon as the gas enters the chamber, peaks sooner and ends sooner as well. In curves 822 and 824, the rotation angles are relative angles, relative to a time when gas input takes place. Gas may enter the expanding chamber at a true rotation angle ranging from zero to about 50 degrees of rotation.

Of course, while the torque is still very significant at 90 degrees of rotation, another cycle is already beginning within the turbine 100, as a new chamber is created with every quarter of a revolution. This compares favorably with a piston in a four-stroke engine, igniting once ever 720 degrees of rotation. As a result, an additional curve such as curve 820, 822 or 824 is initiated and added at every 90 degrees of rotation of the turbine 100, and the net output torque of the turbine 100 is relatively constant and flat.

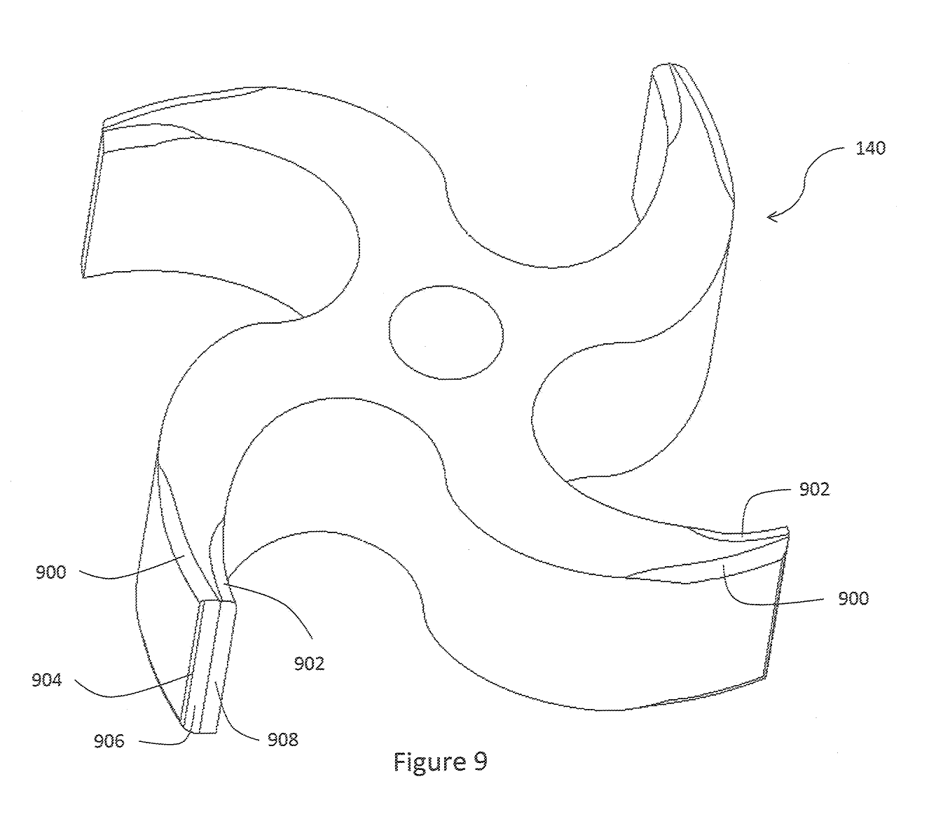

As mentioned hereinabove, mechanical tolerances between the rotors 130, 140 themselves as well as between then rotors various surfaces of the housing 110 may be relatively relaxed. A modest amount of gaseous or fluidic leakage between the various chambers within the turbine 100 is not detrimental to its performance. In fact, any leakage occurs from high pressure chambers to lower pressure chambers, creating at least some modest level of torque in those constant volume chambers, minimizing net losses. If gases exiting the turbine 100 through the output ports 150, 152, 154 are fed to a secondary turbine, net losses are minimized even further. In addition, Bernoulli effects may occur within the turbine 100 at high rotating speeds. In order to circumvent these effects, optional embodiments of the rotors such as shown on FIGS. 9-11 may be used.

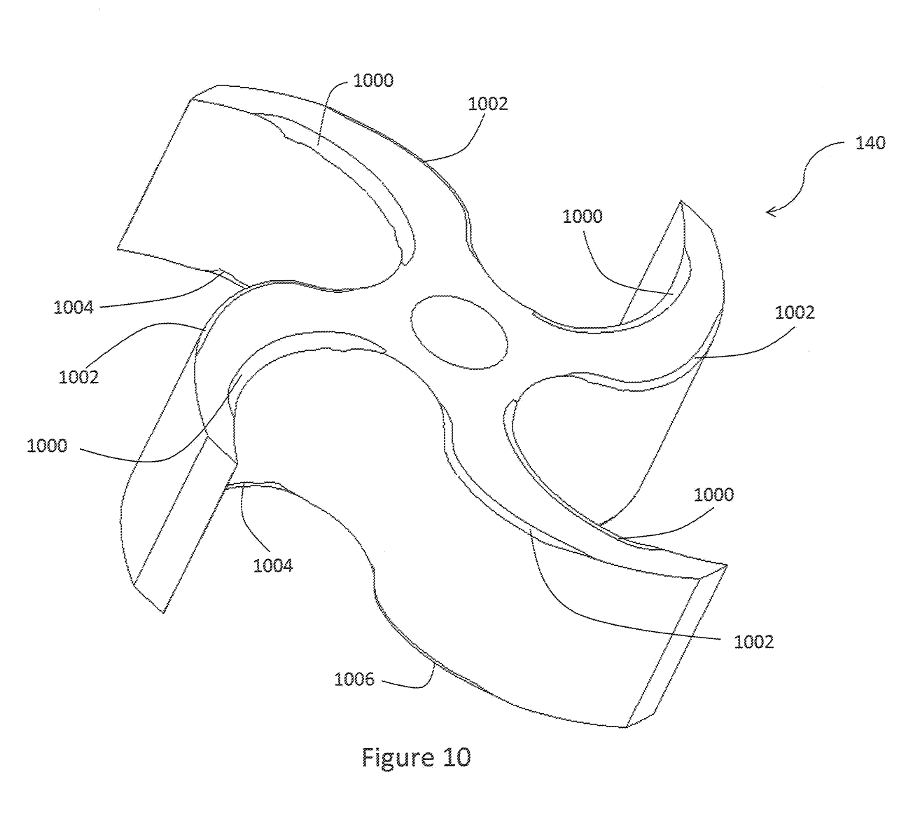

FIG. 9 is a partial perspective view of a rotor according to an embodiment. The rotor 140 is modified by use of various indentations 900-908 near a tip of the arms of the rotor. FIG. 10 is a perspective view of a rotor according to another embodiment. In this case, the rotor 140 is modified by use of different indentations 1000-1006 in mid-sections of the arms of the rotor. These geometries using tapered edges on the arms of the rotors facilitate admission of a fluid into the chambers and minimize turbulence and adverse aerodynamic effects. Though shown as sharp edges on FIGS. 9 and 10, the indentations 900-908 and 1000-1006 may actually form smooth curved surfaces, thereby benefiting from a Bernouilli effect for creating a restriction to flows between fixed and mobile surfaces. It may be observed that the use of indentations 900-908 and 1000-1006 render unnecessary the presence of joints, such as piston rings of conventional engines. Regardless, any leak from one chamber within the turbine 100 only allows gas to flow into a lower pressure adjacent chamber. This gas, added to the lower pressure chamber, generates some torque on the rotors 130, 140. As a result, leaks cause no significant loss of efficiency and, because no joint is present, friction losses are also reduced.

Indentations 900-908 and 1000-1006 also allow avoiding mechanical impacts between the rotors 130 and 140 or between the rotors themselves and other components of the turbine 100. As shapes of some turbine components may be plastically altered under high heat, high pressure and/or high speed conditions, these indentations may prevent collisions between moving parts and between moving and fixed parts. Some attenuation in the geometry of the rotors 130 and 140, creating small gaps between tips of their arms 131-134 and 141-144 and other fixed or mobile surfaces, may further reduce any risk of mechanical shocks between the rotors.

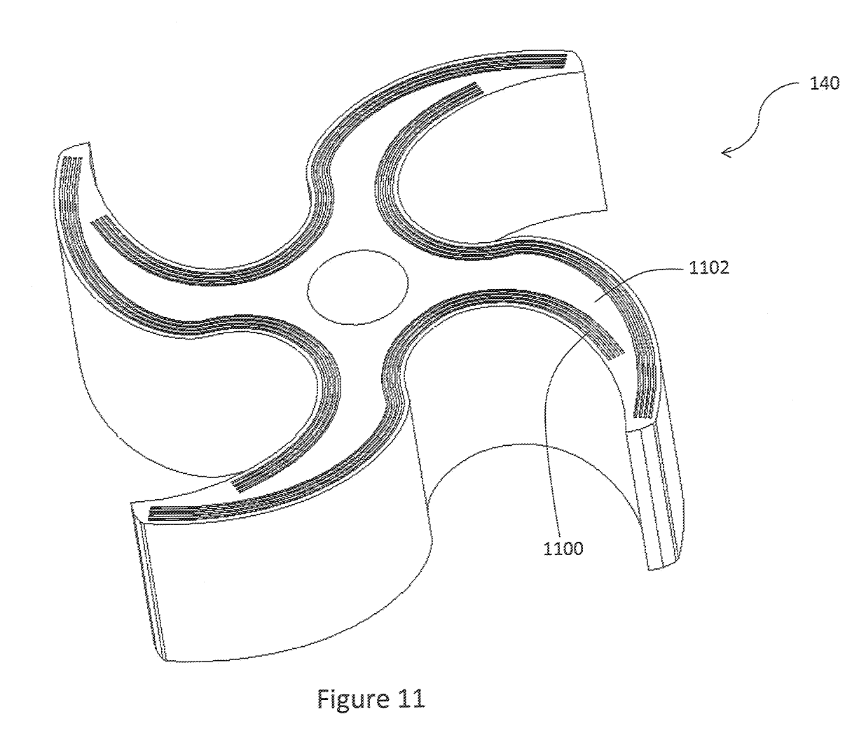

FIG. 11 is a partial perspective view of a rotor according to yet another embodiment. In that embodiment, ridges, grooves or similar patterns 1100 are present on an upper surface 1102 and on a lower surface (not shown) of the rotor 140. The pattern 1100 minimizes any gaseous or fluid leakage between the rotor 140 and the top and bottom of the housing while minimizing friction. In an embodiment, ridges, grooves or similar patterns may alternatively or additionally be present on the upper surface 1102 and on the lower surface of the rotor 140, with similar effects.

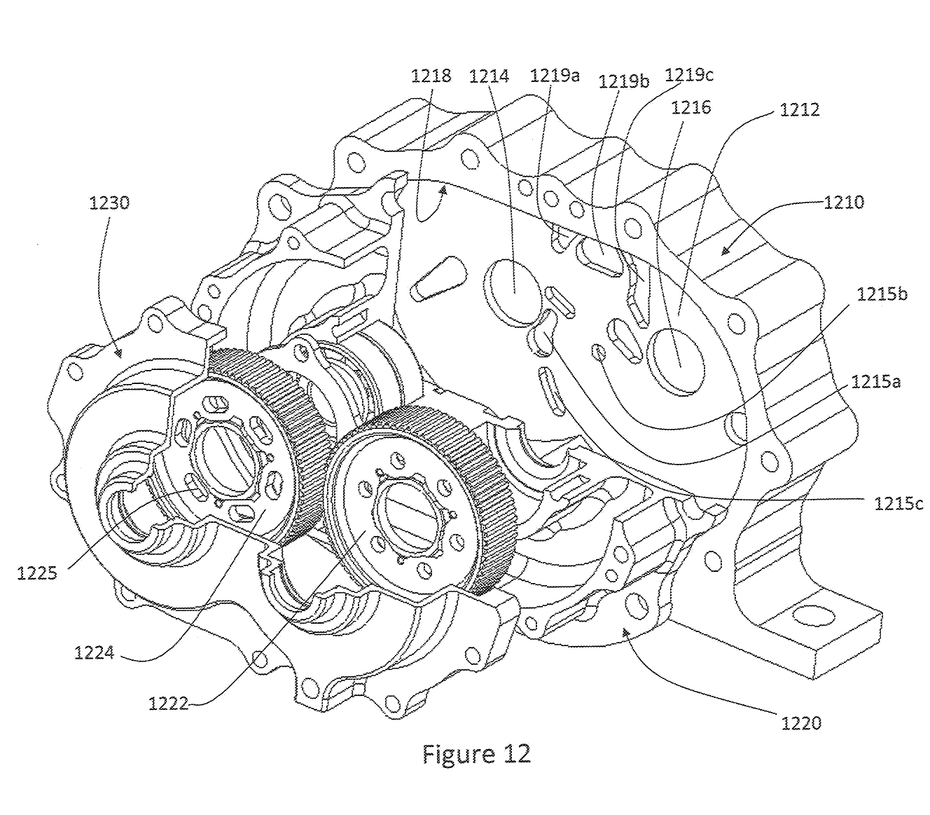

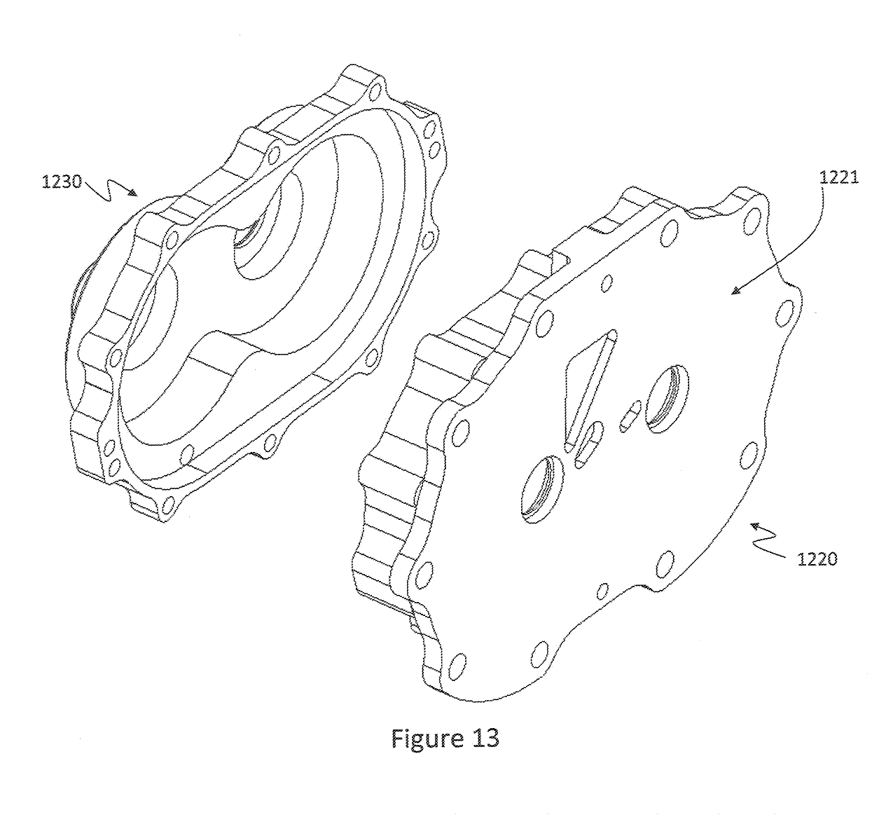

FIG. 12 is a photograph of some components of a turbine prototype. In this embodiment, a top surface 1212 and a perimeter 1218 of the housing are integrated in a same component 1210. The top surface 1212 and the perimeter 1218 come in edging contact with the rotors. Also visible are two axes 1214 and 1216, input ports 1215a, 1215b, and 1215c, and output ports 1219a, 1219b and 1219c, all input ports and output ports being located within the top surface 1212. A bottom part 1220 has a surface (underneath, not shown) that comes in edging contact with rotors. The bottom part 1220 as shown comprises two meshed synchronizing gears 1222, 1224 that connect to the rotors through shafts (not shown). FIG. 12 also shows a cover 1230 for protecting the meshed synchronizing gears 1222, 1224. On the synchronizing gear 1224, non-circular orifices 1225 are provided in order to allow slight angular adjustment of a rotor connected thereto.

FIG. 13 is a second photograph of components of the turbine prototype. The cover 1230 is shown, as well as a bottom surface 1221 of the bottom part 1220.

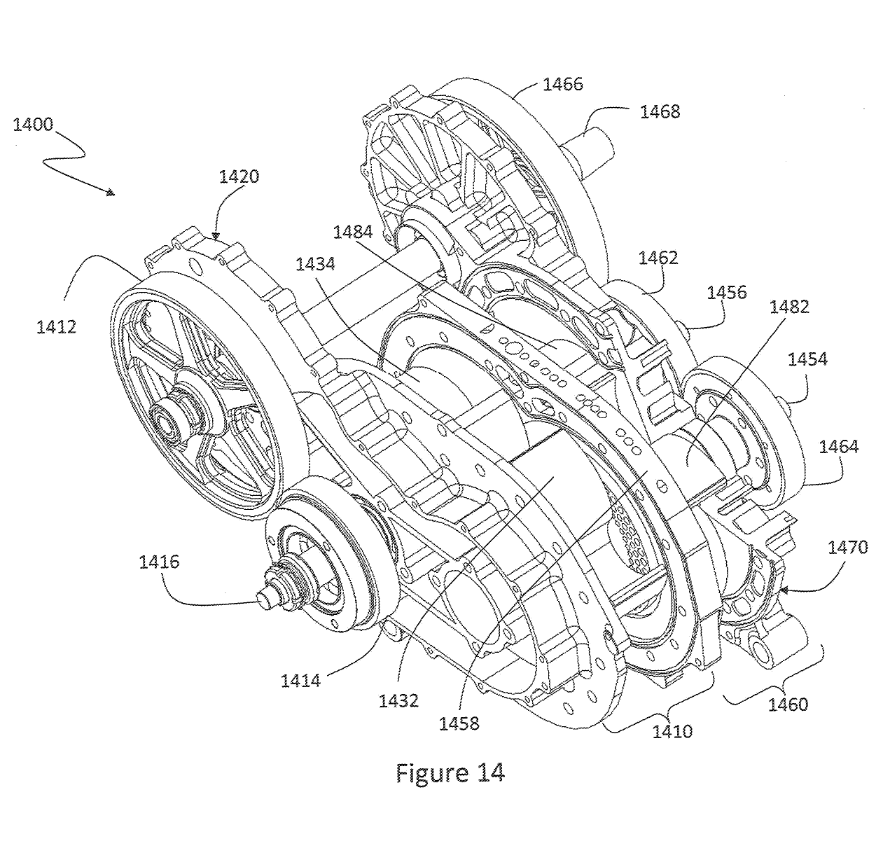

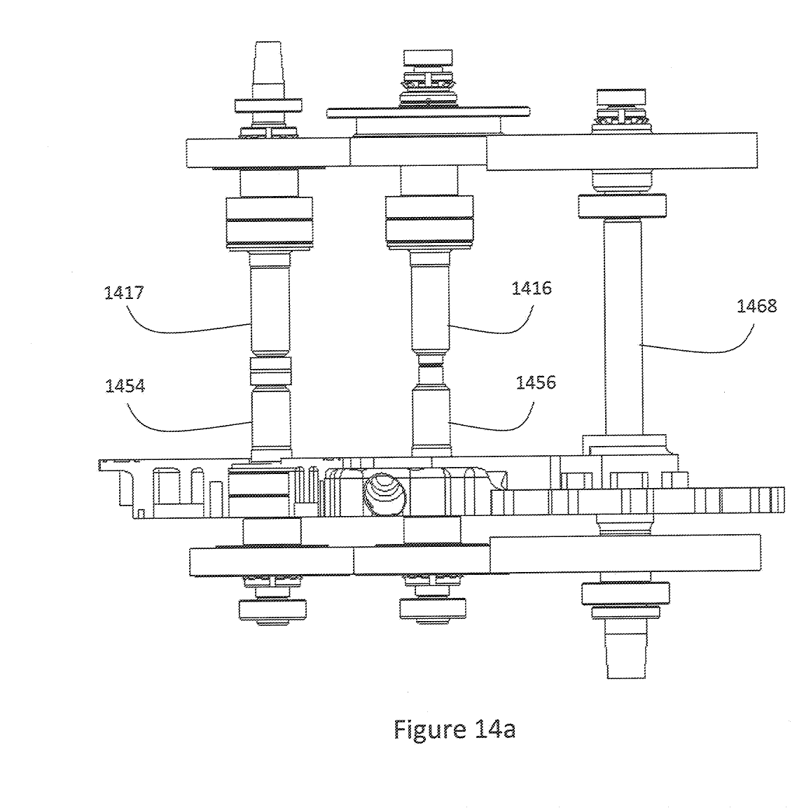

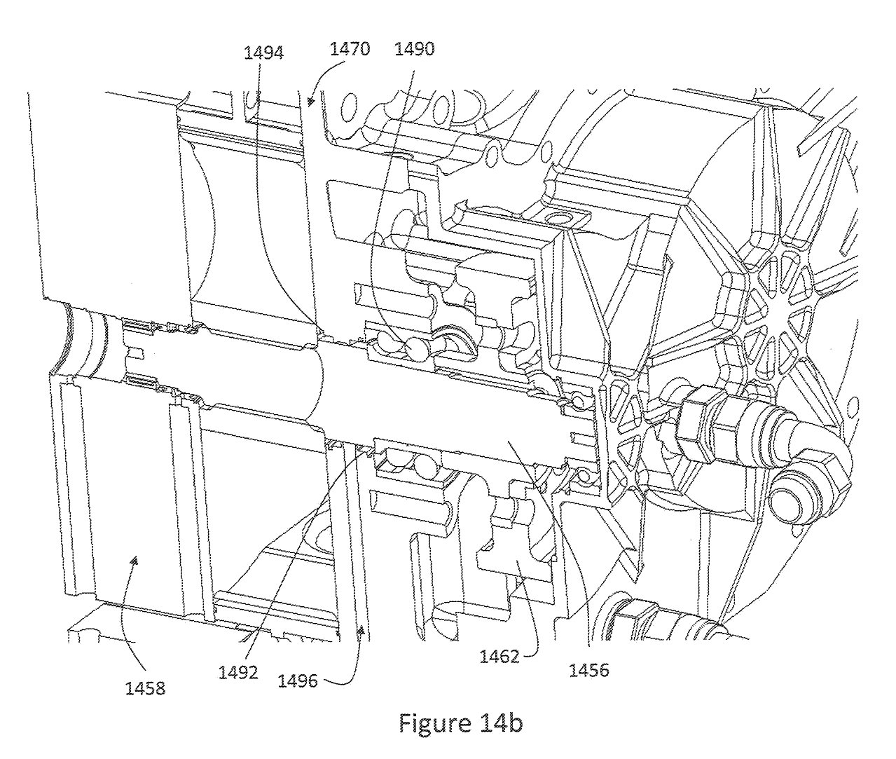

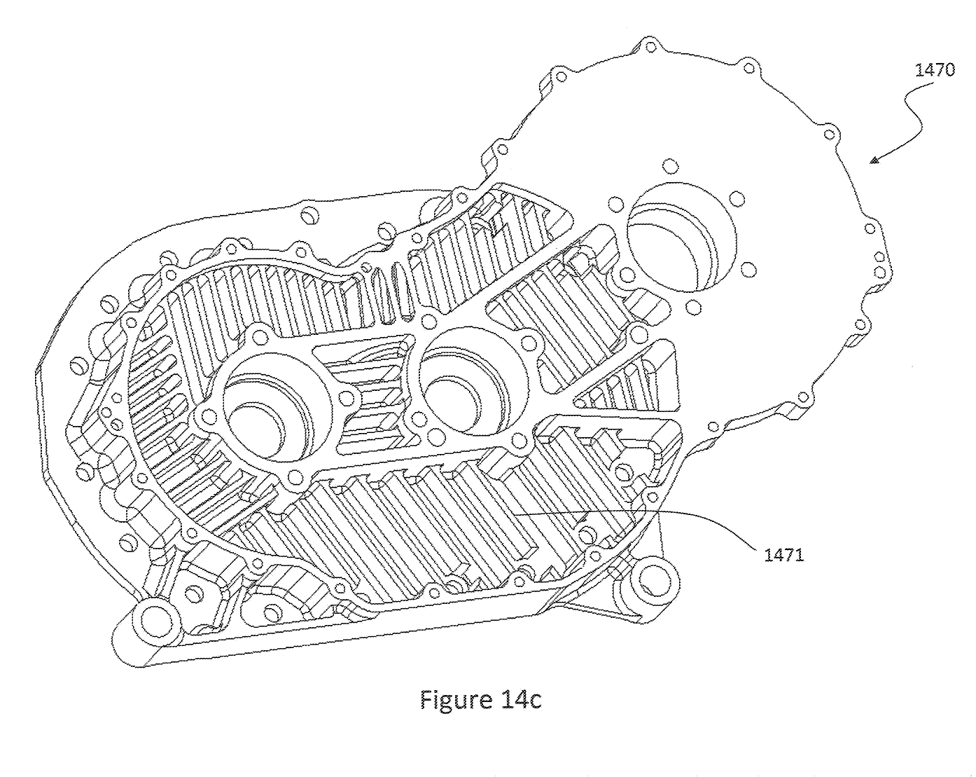

Owing to the capabilities of the turbine 100 to compress a gas when a torque is applied and to create a torque when gas pressure is applied, the turbine 100 may, in an embodiment, be used as a building block for producing a motor. The motor acts as a four-cycle motor in which admission and compression cycles are made in a first turbine while combustion and exhaust cycles are continuously and concurrently made in a second turbine, as in the case of a conventional gas turbine. FIG. 14 is a perspective view showing some parts of a motor according to an embodiment. An exemplary motor 1400 may use various types of combustible fuels to generate power. The motor 1400 comprises two distinct turbines working in opposite modes, a compression turbine 1410 and a combustion turbine 1460. The compression turbine 1410 forms a “cold side” of the motor 1440, operating in reverse mode, while the combustion turbine 1460 forms a “hot side”, operating in same mode as described in relation to FIGS. 2-6. Though similar, the compression turbine 1410 and the combustion turbine 1460 may differ in terms of size, volumes, materials used for their manufacturing, cooling or lubricating means, and the like. The compression turbine 1410 compresses air, or an air and fuel mixture, and provides the compressed gas to the combustion turbine 1460. Fuel may be mixed with air at various stages. A fuel supply system may comprise a carburetor or an injector adding fuel to air for input in the compression turbine 1410, an injector, supplying fuel directly in the combustion turbine 1460, or an injector supplying fuel in an intermediate conduit (not shown) between the two turbines.

The compression turbine 1410 has a top part 1420 while the combustion turbine 1460 has a bottom part 1470. Perimeters of the two turbines 1410, 1460 are not shown in order to show rotors 1432, 1434 of the compression turbine 1410 and rotors 1482, 1484 of the combustion turbine. Though distinct, the two turbines 1410, 1460 may optionally share some components. For example, a plate 1458 is at once a bottom part of a housing for the compression turbine 1410 and a top part of a housing for the combustion turbine 1460. The plate 1458 may comprise output ports (not shown) for the compression turbine 1410, internally connected to one or more input ports (not shown) for the combustion turbine 1460. As such, the plate 1458 may be a transfer plate for transferring the output of the compression turbine 1410 directly into the input of the combustion turbine 1460.

In an embodiment an output port on the compression turbine 1410 is within the plate 1458 and the output port communicates directly therethrough with an input port of the combustion turbine 1460, allowing the compressed air or air and fuel mixture to enter the combustion turbine 1460. In this case, the combustion turbine 1460 comprises ignition means, such as a spark plug (not shown), and ignition of the air fuel mixture takes place within the combustion turbine 1460. In another embodiment, one or more output ports of the compression turbine 1410 are connected with one or more input ports of the combustion turbine 1460 through an intermediate conduit, in which case ignition may take place either within the intermediate conduit or within the combustion turbine 1460. Regardless, combustion generates high pressure within chambers of the combustion turbine 1460, this high pressure acting on rotors to generate a torque.

As shown, the compression turbine 1410 comprises a shaft 1416 connected to the rotor 1434, a second shaft connected to the rotor 1432 being omitted from the figure. Alternatively, shafts 1456 and 1454 may extend through the axes of rotors within the two turbines 1410 and 1460, substituting for the shaft 1416 and acting as a shaft for the rotor 1432. The combustion turbine 1460 is connected by use of the shafts 1456 and 1454 to two counter-rotating synchronizing wheels 1462 and 1464. The synchronizing wheels 1462 and 1464 as shown are frictionally connected. The synchronizing wheel 1464 transmits output torque from the shaft 1454 to the synchronizing wheel 1462, which in turn transmits a sum of this torque and of a torque from the shaft 1456 to a pick-up wheel 1466. The pick-up wheel is mounted on an output shaft 1468, from which a complete output torque from the motor 1400 may be used. A fraction of the output torque from the motor 1400 may be used to drive the compression turbine 1410, a remainder of the output torque forming a net output of the motor 1400. The output shaft 1468 may extend towards a transfer wheel 1412. The transfer wheel 1412 is operably connected to an input wheel 1414, further connected to the shaft 1416 and, therethrough, to the rotor 1434. Of course, the rotor 1432 is also connected to a shaft (not shown), itself connected to another input wheel (not shown) driven by the input wheel 1414. While synchronizing wheels 1462 and 1464 act to synchronize the rotors 1482 and 1484 within the combustion turbine 1460, the combustion turbine 1460 is further synchronized with the compression turbine 1410 via shafts 1468 and 1416 or, alternatively via shafts 1454 or 1456, which may all act as synchronizing shafts. Phase adjustment of the compression turbine 1410 and the combustion turbine 1460 may be obtained by adjusting the input wheel 1414 and the input wheel connected to the rotor 1432.

In the exemplary embodiment of FIG. 14, the rotors 1432 and 1482 rotate in a same direction, opposite of the rotation of the rotors 1434 and 1484. Owing to the compression function of the compression turbine 1410, it operates in reverse mode compared to the basic turbine function described in relation to FIGS. 2-6. In contrast, owing to its torque generating function, the combustion turbine 1460, operates directly according to the basic function of FIGS. 2-6. It may therefore be observed that the rotors 1432, 1434 of the compression turbine 1410 have arms that are curved in an opposite direction compared to those of the rotors 1482, 1484 in the combustion turbine 1460. When the output port on the compression turbine 1410 is within the plate 1458, communicating directly therethrough with an input port of the combustion turbine 1460, both turbines rotate synchronously. When output ports of the compression turbine 1410 communicated with input ports of the combustion turbine via an intermediate conduit, the two turbines may operate at distinct speeds. For example, in an embodiment, the compression turbine 1410 may be physically smaller and rotate at a higher speed, thereby providing ample air or air and fuel supply to the combustion turbine 1460.

FIG. 14a is a partial cutaway view of the motor of FIG. 14. The figure shows the shafts 1454, 1456, 1468 and 1416 of FIG. 14, and a shaft 1417 connected to the rotor 1432.

FIG. 14b is another partial cutaway view of the motor of FIG. 14. One of the shafts, for example the shaft 1456 is shown with the synchronizing wheel 1462. Also shown are the bottom part 1470 and the common plate 1458. A bearing 1490 maintains the shaft 1456 in place. Because there may be grease or oil (not shown) surrounding the bearing 1490 and because there are gases between the common plate 1458 and the bottom part 1470, where the rotor 1484 (not shown on FIG. 14b) is located, o-rings or similar sealing means may be placed within grooves 1492, 1494, and a canal 1496 may allow any condensation bypassing the o-rings to be guided outside the motor 1400. This prevents contamination of the bearing oil or grease.

FIG. 14c is a detailed view of a bottom part of the motor of FIG. 14. The bottom part 1470 may comprise, on its back (opposite from the rotors 1482, 1484, a plurality of cooling fins 1471 for facilitating heat transfer between the combustion turbine 1460 and oil (not shown) circulating around the bottom part 1470.

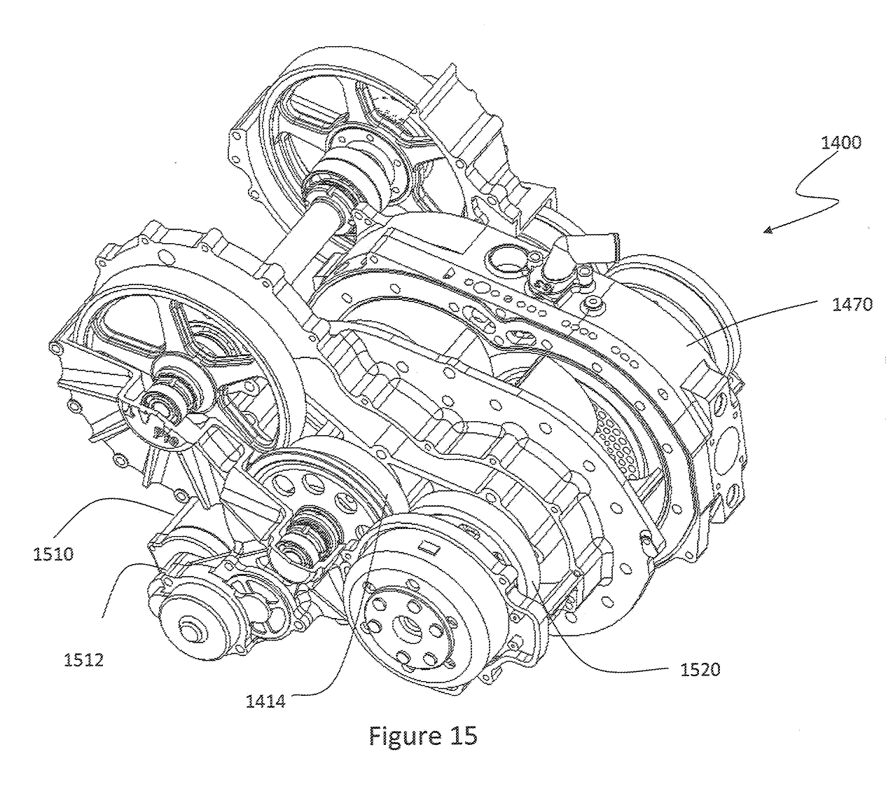

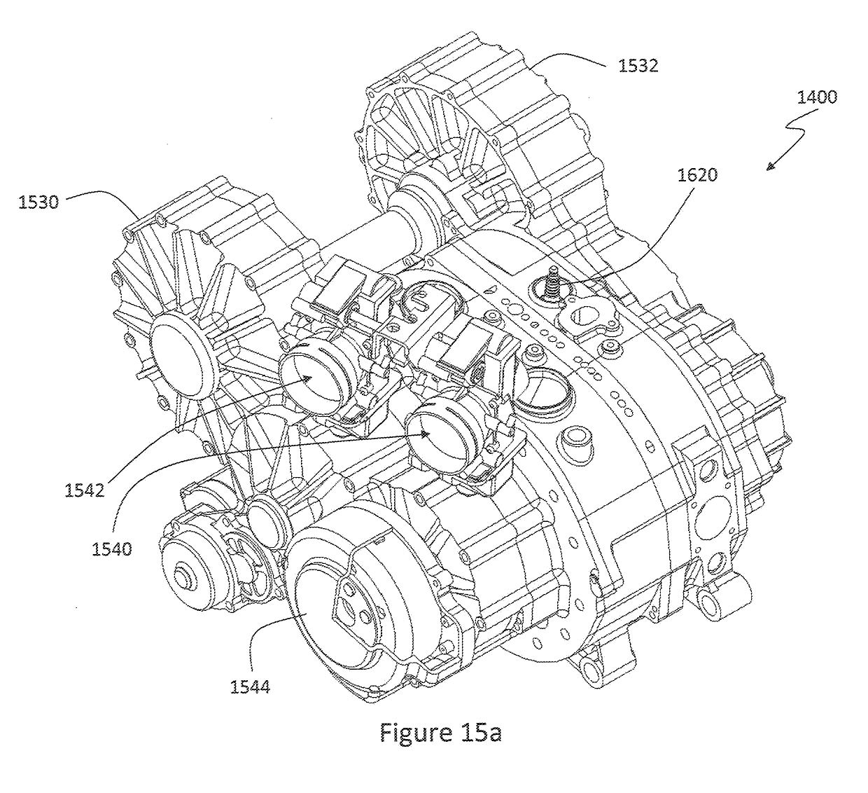

FIG. 15 is another perspective view showing additional parts of the motor of FIG. 14. The motor 1400 further comprises a starter motor 1510 connected to a gear box 1512, which may comprise a one-way bearing, the gear box 1512 being connected to the input wheel 1414. The input wheel 1414 further acts to synchronize rotors of the compression turbine 1410 by use of a frictional contact to a second input wheel 1520. On FIG. 15a, covers 1530, 1532 are added on top of the various wheels 1412, 1414, 1520, 1462, 1464 and 1466. Oil may circulate between the covers 1530, 1532, and the top and bottom parts 1420, 1470, respectively. FIG. 15a also shows carburetors 1540, 1542, a spark plug 1620, and a dynamo 1544.

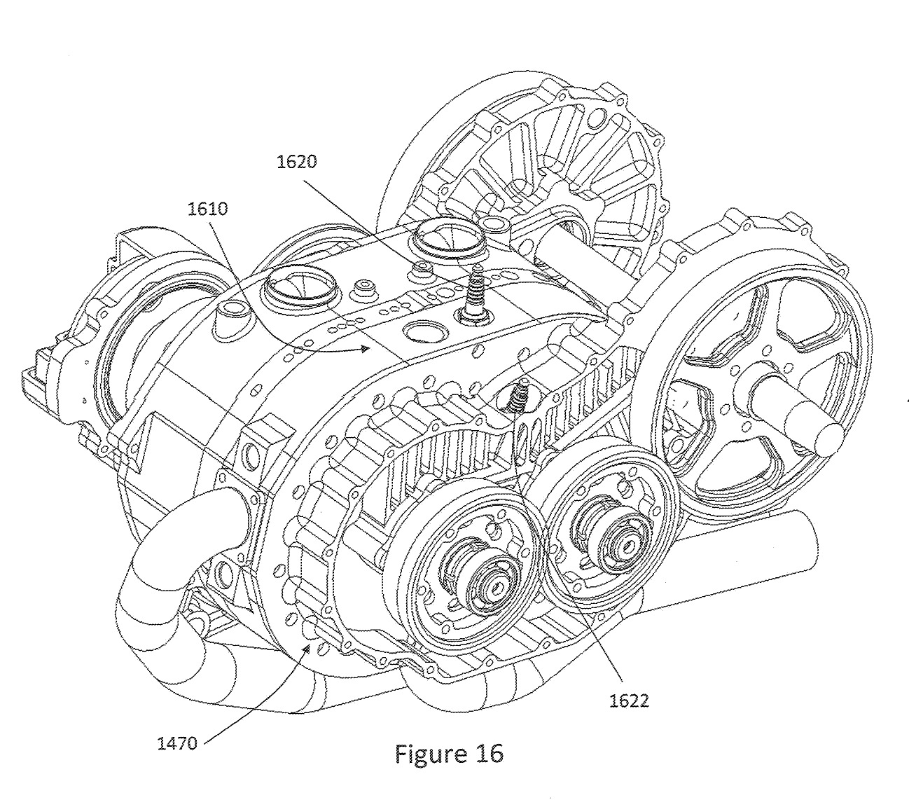

FIG. 16 is a perspective view showing details of the motor of FIG. 14. A perimeter 1610 is attached to the bottom part 1470 of the combustion turbine 1460. Two distinct spark plugs 1620, 1622 are shown, though in an embodiment, a single spark plug 1620 or 1622 may be used. The spark plug 1620 is affixed to the perimeter 1610 and its electrode (not shown) may provide a spark within an expanding chamber of the combustion turbine 1660, igniting a compressed air and fuel mixture positioned for example as the chamber A of FIG. 4. The spark plug 1622 is affixed to the bottom part 1470 and may provide a spark within another expanding chamber of the combustion turbine 1460, igniting the compressed air and fuel mixture positioned for example as the chamber A of FIG. 3. Of course, various placements of the spark plugs and various angular rotations of the rotors of the combustion turbine 1460 may be used depending on diverse factors such as a type of fuel, a ratio of fuel per volume of air, a rotational speed of the motor, a compression ratio, and like parameters. As in the case of traditional engines, ignition timing may vary with various factors such as a revolution speed of the motor 1400. Additional spark plugs (not shown) may also be placed within conduits or spaces used for recuperation of pressurized gases, enabling a more complete combustion.

It may be observed that ignition may occur within the combustion turbine 1460 four times per rotation, as a new chamber is created upon every 90 degrees of rotation of the rotors. Alternatively, ignition may occur at similar rates, or continuously, within an intermediate conduit between the compression turbine 1410 and the combustion turbine 1460. In either case, combustion pressure within the combustion turbine 1460 is consistently present. This compares to one ignition with every two revolutions within a traditional four-stroke cylinder. It may also be observed that, within the combustion chamber 1460, pressure within a chamber consistently generates torque, owing to the geometry of the rotors. As a result, a serious problem of traditional combustion engines, in which maximum pressure at top-dead center coincides with no torque output, does not occur. The motor 1400 thus operates more efficiently, generates a smoother torque output, generates less heat, and produces significantly less nitrous oxide (NOx).

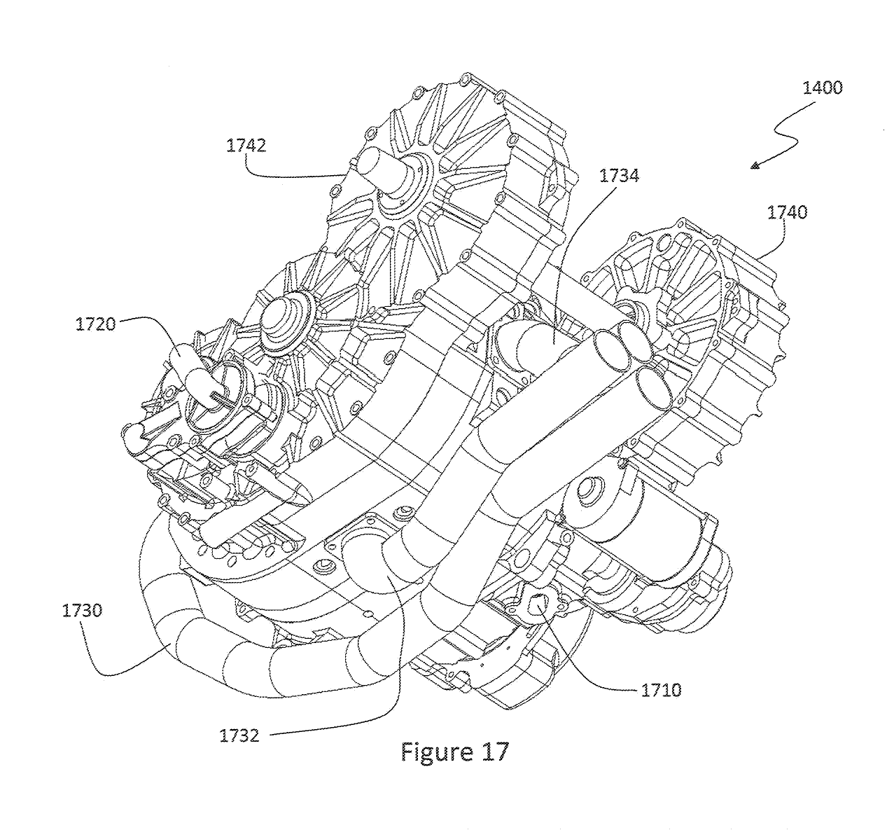

FIG. 17 is a perspective view showing the complete motor of FIG. 14, cooling means being omitted. Those skilled in the art will understand that the motor could be cooled by one or several types of cooling means: water-cooled, oil-cooled, re-circulated coolant, chiller, heat exchanger, air cooling with blades, etc. The motor 1400 has passages 1710, 1720 for oil circulation between the two turbines, ensuring proper heat transfer and ensuring proper lubrication of the various moving components external to the turbines. In an embodiment, oil circulation may alternatively take place through orifices within the plate 1458. The combustion side has three output ports (not shown) connected to exhaust pipes 1730, 1732, 1734. In an embodiment, not all three output ports and exhaust pipes may be present. Covers 1740 and 1742 protect the various wheels 1462, 1464, 1466, 1412, 1414 and 1520, thereby completing the motor.

Of course, variations from the basic structure of the motor of FIGS. 14-17 could be considered. In an embodiment, two turbines may be separated and not share common components such as the common shafts 1456 and 1460 or the common plate 1458. Alternatively, one of the shafts 1456 or 1454 may act as a synchronizing shaft and as an output shaft, thereby substituting for at least some of the functions of the shaft 1468. In another embodiment, the synchronizing wheels 1462, the pick-up wheel 1464, the transfer wheel 1412, the input wheel 1414 and second input wheel 1520 may be meshed gears, similar to gears 1222, 1224 shown on FIG. 12. Further, sizes of the rotors in the two turbines 1410 and 1460 may differ. For example, rotors that are larger in diameter or in width (or depth) may be used in the compression turbine 1410. In an embodiment using distinct shafts in the axes of the rotors for the two turbines, distinct rotation speeds of the turbines may be attained. Using a larger compression turbine 1410 or using a higher rotation speed in the compression turbine 1410 provides more of the compressed air and fuel mixture to the combustion turbine 1460. This supercharges the motor 1400, using much simpler means compared to traditional turbochargers or superchargers used with alternating piston engines. In a variation, a larger combustion turbine 1460 may extract more energy from combustion and leave less residual pressure in exhaust gases. Of course, building a motor using the turbine 100 as a basic building block is not limited to using two turbines, as various numbers of compression turbines could be used with various numbers of combustion turbines, in various combinations. For example, an additional turbine may be connected to the output ports of the combustion turbine in order to recuperate parts of its residual heat and pressure.

The motor 1400 may operate with ordinary gas, methanol, ethanol, diesel fuel, and the like, some adaptations being made to adapt to a chosen fuel type. As is well-known to those of ordinary skill in the art, in the case where diesel fuel is used, fuel pressure, compression levels, ignition means, electronic control means, and the like differ from the case where ordinary gas is used.

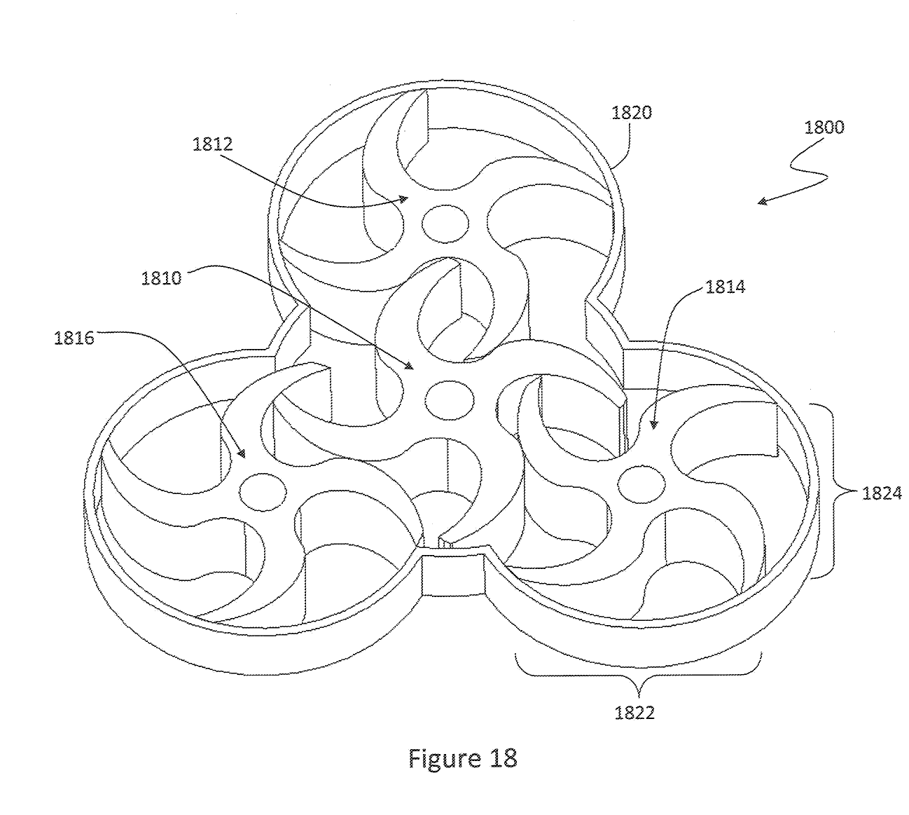

FIG. 18 is a schematic view of an alternate embodiment of a turbine. A turbine 1800 comprises four distinct rotors 1810, 1812, 1814 and 1816 located in a same plane within a perimeter 1820, the four rotors having a same depth and a same diameter. The central rotor 1810 may rotate clockwise while the peripheral rotors 1812-1816 may rotate counter-clockwise. A relationship within a pair comprising the rotor 1810 at the center of the turbine 1800 and any of the surrounding rotors is similar to that of the pair of rotors 130, 140 of FIGS. 1-6, except that a chamber created between arms of two rotors is eventually confined in part by a third rotor, after some level of expansion. While a behavior of the various chambers is more complex than in the case of the turbine 100, the turbine 1800 operates in a similar manner. Input ports (not shown) may be present in a top part (not shown) or in a bottom part (not shown) of the turbine 1800, near an axis of rotation of the central rotor 1810, where new chambers are created by the rotation of the rotors. Output ports (not shown) may be present in the top part, bottom part, or in the perimeter 1820, for examples in areas such as 1822 or 1824 where chambers are neither contracting nor expanding. While FIG. 18 shows an embodiment having four rotors, another embodiment could comprise three rotors, comprising one central rotor and two diametrically opposed peripheral rotors. A number of rotors surrounding the central rotor guides their positioning around a perimeter of the turbine. A torque output from a multi-rotor turbine 1800 is even more constant when compared to that of a conventional piston engine because of a phase difference between the various chambers being created around the central rotor.

Those of ordinary skill in the art will realize that the description of the turbine and of the motor are illustrative only and are not intended to be in any way limiting. Other embodiments will readily suggest themselves to such skilled persons having the benefit of this disclosure. Furthermore, the disclosed turbines and motors can be customized to offer valuable solutions to existing needs and problems related to the manufacturing costs and lack of efficiency of current compressors, turbines, pumps for incompressible fluids, and motors.

In accordance with this disclosure, the turbine components described herein may be implemented using various materials such as diverse metals and alloys, plastic, polymers, ceramics, and combinations thereof. Notably, a rotor and a rotating valve attached thereto may be made using distinct materials or distinct surface treatment. Selection of materials used for manufacturing the various components of the turbine would be based on considerations such as operating pressure, operating speed, operating temperature, nature of the fluids within the turbine, expected durability of the turbine, cost considerations and similar considerations.

In the interest of clarity, not all of the routine features of the implementations of turbines and motors are shown and described. It will, of course, be appreciated that in the development of any such actual implementation of the turbine, numerous implementation-specific decisions must be made in order to achieve the developer's specific goals, such as compliance with application-, system- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of energy conversion having the benefit of this disclosure.

Although the present disclosure has been described hereinabove by way of non-restrictive illustrative embodiments thereof, these embodiments can be modified at will within the scope of the appended claims without departing from the spirit and nature of the present disclosure.

What is claimed is:

1. A turbine, comprising:
a housing having a perimeter connected to a top and a bottom, an input port and at least one output port: and
two counter-rotating rotors enclosed within the housing, each rotor having an axis of rotation, a thickness for slightly spaced or barely contacting relation with the top and the bottom of the housing, and four curved arms;
wherein the arms of a first rotor are curved in a direction of rotation of the first rotor, the arms of a second rotor are curved in the direction of rotation of the first rotor, a diameter of each one of the rotors extends in length for slightly spaced or barely contacting relation of a tip of the arms to the perimeter of the housing over at least 90 degrees of rotation of the rotors, a distance between the two axes being such that the tip of an arm of the first rotor comes in slightly spaced or barely contacting relation with the second rotor between two arms of the second rotor at some angle of rotation;
whereby, as the two rotors rotate, chambers are formed between some of the arms of the two rotors and between some of the arms and the perimeter of the housing, in continuously varying shapes, volumes of the chambers being delimited by these shapes and further delimited by the top and the bottom of the housing, a first chamber defined between some arms of the two rotors and the perimeter of the housing being in an expansion phase when a second chamber is created and starts to expand between some arms of the two rotors, one of the first and second chambers being in connection with the input port, the first and second chambers expanding while at least a third chamber is in connection with the at least one output port.

2. The turbine of claim 1, wherein:
the perimeter of the housing is formed as two partially overlapping circles sized for slightly spaced or barely contacting relation with the arms of the rotor.

3. The turbine of claim 2, comprising:
an output port on the perimeter of the housing where the two partially overlapping circles meet, at a point of the perimeter that is diametrically opposed from the first chamber.

4. The turbine of claim 2, comprising:
an output port on the top or bottom of the housing, near a point of the perimeter where the two partially overlapping circles meet, the point being diametrically opposed from the first chamber.

5. The turbine of claim 1, comprising:
two diametrically opposed output ports on the perimeter of the housing.

6. The turbine of claim 1, comprising:
two diametrically opposed output ports on top or bottom of the housing.

7. The turbine of claim 1, wherein:
the arms have tapered edges over at least a part of their lengths or tips.

8. The turbine of claim 7, wherein:
a shape of the arms is plastically altered under speed, pressure or heat conditions while maintaining slightly spaced or barely contacting relations within the turbine.

9. The turbine of claim 1, wherein:
the rotors have patterned upper and lower surfaces;
whereby fluidic leakage between the rotors and the top and bottom of the housing is minimized.

10. A turbine, comprising:
a housing having an input port and at least one output port;
two rotors enclosed within the housing and counter-rotating in a same plane; and
a plurality of chambers formed within the housing and delimited by arms of the rotors;
wherein the arms of the rotors cooperate in their rotation to create a first chamber and a second chamber, the first chamber and the second chamber concurrently expanding as the rotors rotate, the first chamber starting to expand earlier than the second chamber, one of the first and second chambers being in connection with the input port, a third chamber being in contact with the at least one output port.

11. The turbine of claim 10, wherein:
the input port is for injecting a fluid under pressure;
the fluid under pressure forces the expansion of the first and second chambers; and
an output shaft operably connected to at least one of the two rotors is for outputting torque from the turbine.

12. The turbine of claim 10, comprising:
an input shaft operably connected to at least one of the two rotors for receiving torque;
wherein a direction of rotation of the rotors is reversed, fluid is supplied at the at least one output port at a low pressure, the torque forces contraction of the first and second chambers, and the input port is for expelling pressurized fluid.

13. The turbine of claim 10, wherein:
the input port is located in the top or in the bottom of the housing;
the second chamber is initially formed and starts expanding over a location of the input port; and
expansion of the second chamber creates aspiration of a fluid from the input port.

14. The turbine of claim 10, further comprising:
a valve for opening and closing the input port.

15. The turbine of claim 10, wherein:
the at least third chamber pushes fluid through the at least one output port.

16. The turbine of claim 10, further comprising:
a valve for opening and closing the at least one output port.

17. The turbine of claim 10, further comprising:
two counter-rotating synchronizing wheels placed outside of the housing, in connection to the two rotors.

18. The turbine of claim 10, wherein:
the turbine is a combustion turbine;
a second turbine is a compression turbine operating in reverse mode from the combustion turbine;
a synchronization shaft is operably connected to at least one rotor of each turbine;
the compression turbine is for providing compressed air to the input port of the combustion turbine;
fuel is mixed with air by a fuel supply system selected from the group consisting of a carburetor and an injector;
the combustion turbine comprises an ignition mechanism; and
an output shaft is operably connected to at least one of the two rotors of the combustion turbine for receiving torque therefrom.

19. The turbine of claim 18, wherein:
the output shaft is the synchronization shaft.

20. The turbine of claim 18, wherein:
the output shaft and the synchronization shaft are distinct shafts.

21. The turbine of claim 18 wherein:
the combustion turbine and the compression turbine are of different sizes.

22. The turbine of claim 10, comprising:
three rotors enclosed in a same plane within the housing, wherein:
the first rotor is centrally located within the housing,
the second rotor and a third rotor surround the first rotor and rotate an opposite direction from the direction of rotation of the first rotor;
a plurality of input ports in the top or bottom of the housing, the plurality of input ports being disposed near the axis of rotation of the first rotor; and
a plurality of output ports around the perimeter of the housing;
whereby, as the rotors rotate, chambers are formed between some of the arms of the first rotor and some of the arms of the second and third rotors, each chamber being formed and starting to expand while in connection with one of the plurality of input ports, each chamber moving towards one of the plurality of output ports after the end of its expansion phase.

23. A motor, comprising:
a combustion turbine operating in a first mode comprising:
a housing having an input port and at least one output port,
two rotors enclosed within the housing and counter-rotating in a same plane,
a plurality of chambers formed within the housing and delimited by arms of the rotors,
an ignition mechanism, and
an output shaft is operably connected to at least one of the two rotors,
wherein the arms of the rotors cooperate in their rotation to create a first chamber, the first chamber and at least a second chamber concurrently expanding as the rotors rotate, the second chamber starting to expand earlier than the first chamber, one of the first and second chambers being in connection with the input port, a third chamber being in contact with the at least one output port;
a compression turbine, operating in reverse mode from the first mode of combustion turbine, for admitting and compressing an air and fuel mixture and for providing the compressed air and fuel mixture to the input port of the combustion turbine; and
a synchronization shaft operably connected to each turbine;
wherein the output shaft is for receiving torque from at least one of the two rotors.

24. The motor of claim 23, wherein:
the compression turbine has larger chambers than the combustion turbine;
whereby the motor is supercharged.

25. The motor of claim 23, wherein:
The compression turbine and the combustion turbine rotate at distinct speeds.
